(19) United States
(12) Patent Application Publication
(10) Pub. No.: US 2026/0349654 A1
(43) Pub. Date: Nov. 5, 2026

(54) ARITHMETIC APPARATUS, SIGNAL PROCESSING APPARATUS, AND SIGNAL PROCESSING CIRCUIT

(71) Applicant: SONY SEMICONDUCTOR SOLUTIONS CORPORATION, KANAGAWA (JP)

(72) Inventors: MASAKI SAKAKIBARA, KANAGAWA (JP); KENJI NOGUCHI, KANAGAWA (JP); NORIAKI MAEDA, KANAGAWA (JP); KATSUHIKO HANZAWA, KANAGAWA (JP)

(21) Appl. No.: 19/486,614

(22) PCT Filed: May 16, 2024
(86) PCT No.: PCT/JP2024/018142

§ 371 Date: Nov. 21, 2025

(30) Foreign Application Priority Data
Jun. 1, 2023 (JP) 2023-091013
Jan. 24, 2024 (JP) 2024-008968

(51) Int. Cl. G06F 7/487

(52) U.S. Cl. CPC G06F 7/4876

(57) ABSTRACT

[Object] To enable power saving and area saving to be realized.

[Solving Means] Provided is an arithmetic apparatus including: a first capacitor connected between a first node and a reference voltage node; a plurality of second capacitors connected in series to a signal path between the first node and a second node; and a plurality of third capacitors having one ends connected to connection nodes of the first capacitor and the plurality of second capacitors, in which a first digital signal is used to set which of a voltage corresponding to a second digital signal and a predetermined reference voltage is to be applied to other ends of the plurality of third capacitors, and the second node outputs a voltage corresponding to a multiplication result of the first digital signal and the second digital signal.

### TECHNICAL FIELD

The present disclosure relates to an arithmetic apparatus, a signal processing apparatus, and a signal processing circuit.

### BACKGROUND ART

Machine learning such as deep learning has been attracting attention. In machine learning, it is necessary to repeatedly perform a product-sum operation that uses a neural network, and hardware that promptly performs the product-sum operation with a small area and low power consumption is being developed. For example, there is proposed a C-2C ladder structure that can improve product-sum operation energy efficiency in multibit product-sum operations, and also prevent an increase of an area even when a bit count increases (see Non-Patent Literature 1). There is also proposed a technology in which an input signal is generated by a digital pulse signal by a charge distribution (see Non-Patent Literature 2).

### CITATION LIST

### Non-Patent Literature

Non-Patent Literature 1: Hechen Wang et, al. “A 32.2 TOPS/W SRAM Compute-in-Memory Macro Employing a Linear 8-bit C-2C Ladder for Charge Domain Computation in 22 nm for Edge Inference” VLSI 2022, C04-1
Non-Patent Literature 2: Gicheol Shin et, al. “A Charge-Domain Computation-In-Memory Macro with Versatile All-Around-Wire-Capacitor for Variable-Precision Computation and Array-Embedded DA/AD Conversions” ECCIRC 2021, Sungkyunkwan Univ.

### DISCLOSURE OF INVENTION

### Technical Problem

However, Non-Patent Literature 1 requires a digital-to-analog converter circuit (DAC; Digital to Analog Converter) that converts a digital signal for performing a product-sum operation with a weight coefficient set as a power of two into an analog signal, and an analog-to-digital converter circuit (ADC; Analog to Digital Converter) that converts a multiplication result into a digital signal, thereby increasing a circuit area and power consumption.

In Non-Patent Literature 2, SRAM (Static Random Access Memory) cells are arrayed in a row direction and a column direction, and a plurality of switches are provided between the SRAM columns in the column direction, so that product-sum operation processing that uses the SRAM cells is performed by controlling these switches. Since a large number of switches need to be provided, the configuration is complicated, and switch control of the switches is also cumbersome. Also in Non-Patent Literature 2, two multibit operation rows are used to perform a product operation by a charge distribution corresponding to an input signal. Therefore, in order to perform a product-sum operation between two digital signals, the multibit operation rows in a number that is a multiple of two are required, and thus area efficiency of the product-sum operation is poor as compared to a case where the product operation is performed using one multibit operation row.

In this regard, the present disclosure provides an arithmetic apparatus, a signal processing apparatus, and a signal processing circuit that are capable of saving power and space.

### Solution to Problem

To solve the problems described above, according to the present disclosure, there is provided an arithmetic apparatus, including:
a first capacitor connected between a first node and a reference voltage node;
a plurality of second capacitors connected in series to a signal path between the first node and a second node; and
a plurality of third capacitors having one ends connected to connection nodes of the first capacitor and the plurality of second capacitors, in which
a first digital signal is used to set which of a voltage corresponding to a second digital signal and a predetermined reference voltage is to be applied to other ends of the plurality of third capacitors, and
the second node outputs a voltage corresponding to a multiplication result of the first digital signal and the second digital signal.

The one ends of two or more of the third capacitors may be connected to each of the connection node between the first node and the second capacitor adjacent to the first node, the connection node between the two second capacitors adjacent to each other, and the connection node between the second node and the second capacitor adjacent to the second node on the signal path.

The second digital signal may include a plurality of bits, and
each of the bits of the second digital signal may be used for setting a voltage of the other ends of the two or more third capacitors in the connection nodes that differ.

A plurality of the connection nodes may be provided on the signal path, and
the voltage corresponding to the second digital signal or the predetermined reference voltage may be applied to the other ends of the two or more third capacitors connected to each of the plurality of connection nodes, according to corresponding bit values of the same first digital signal.

The two or more third capacitors may have a same capacitance value,
a sum of the capacitance values of the two or more third capacitors may be equal to a capacitance value of the first capacitor, and
the first digital signal may be a thermometer code.

The plurality of third capacitors may have mutually-different capacitance values that each are one over a power of two of a capacitance value of the first capacitor.

A voltage corresponding to a same bit value of the second digital signal may be applied to the other ends of the plurality of third capacitors having the one ends connected to the same connection node on the signal path, and
voltages corresponding to mutually-different bit values of the second digital signal may be applied to the other ends of the plurality of third capacitors having the one ends connected to the connection nodes that mutually differ on the signal path.

Capacitance values of the plurality of second capacitors are the same, and
the capacitance values of the second capacitors may be twice a capacitance value of the first capacitor.

The arithmetic apparatus may further include: an array unit including a plurality of multipliers arrayed in a first direction and a second direction that intersect with each other, and
each of the plurality of multipliers may include the first capacitor, the plurality of second capacitors, and the plurality of third capacitors.

Further, according to the present disclosure, there is provided a signal processing apparatus, including:
an arithmetic apparatus; and
an image pickup unit which outputs captured image data, in which
the arithmetic apparatus includes
a first capacitor connected between a first node and a reference voltage node,
a plurality of second capacitors connected in series to a signal path between the first node and a second node, and
a plurality of third capacitors having one ends connected to connection nodes of the first capacitor and the plurality of second capacitors,
a first digital signal is used to set which of a voltage corresponding to a second digital signal and a predetermined reference voltage is to be applied to other ends of the plurality of third capacitors,
the second node outputs a voltage corresponding to a multiplication result of the first digital signal and the second digital signal, and
at least one of the first digital signal or the second digital signal is a signal that is based on the image data.

Further, according to the present disclosure, there is provided a signal processing circuit, including:
an analog arithmetic circuit which performs first processing for converting a first digital signal into a first analog signal, and performs second processing for varying a second analog signal corresponding to a multiplied value of the first analog signal obtained by the conversion and a second digital signal on the basis of a third digital signal for setting a gain, to generate a third analog signal.

The signal processing circuit may further include:
a plurality of the analog arithmetic circuits that separately perform the first processing and the second processing;
a signal line which transmits a fourth analog signal of a signal level in which a plurality of the second analog signals or a plurality of the third analog signals respectively output from the plurality of analog arithmetic circuits are added; and
an analog-to-digital converter circuit which converts the fourth analog signal obtained by the second processing into a fourth digital signal.

The second processing may include third processing for simultaneously lowering a voltage level on the signal line on the basis of a plurality of the first analog signals, and fourth processing for raising, after the third processing, a voltage of the signal line stepwise on the basis of each of a plurality of the third digital signals, to generate the fourth analog signal.

The signal processing circuit may further include:
a control circuit which controls the plurality of analog arithmetic circuits, and
the control circuit may cause the plurality of analog arithmetic circuits to perform the first processing and the third processing in parallel, and cause the plurality of analog arithmetic circuits to sequentially perform the fourth processing.

Each of the plurality of analog arithmetic circuits may include
two or more first capacitors which accumulate a charge corresponding to the first digital signal, and
a switch which connects the two or more first capacitors in parallel or causes one or more of the two or more first capacitors to charge or discharge in accordance with the first digital signal, and makes a switch as to whether or not to set the remaining first capacitors in a floating state.

Each of the plurality of analog arithmetic circuits may include a ladder multiplication circuit which includes a plurality of second capacitors which are connected in series and each output a voltage that is one over a power of two, one end of the ladder multiplication circuit being connected to the signal line.

The two or more first capacitors may be connected between two of the second capacitors adjacent to each other out of the plurality of second capacitors,
the two or more first capacitors may have a same capacitance, and
each of the plurality of second capacitors may have a capacitance that is twice or more of the capacitance of the first capacitors.

The signal processing circuit may further include:
a plurality of capacitor groups each including the two or more first capacitors,
one end of each of the two or more first capacitors in each of the plurality of capacitor groups may be connected to the signal line,
the two or more first capacitors in each of the plurality of capacitor groups may have a same capacitance, and
the capacitances of the two or more first capacitors in each of the plurality of capacitor groups may differ by a power of two.

The analog-to-digital converter circuit may include
a comparison circuit which determines whether or not the fourth analog signal on the signal line has exceeded a predetermined threshold value, and
a counter which performs a count operation until it is determined by the comparison circuit that the fourth analog signal has exceeded the predetermined threshold value since start of an analog-to-digital conversion operation, and
the analog-to-digital converter circuit may output the fourth digital signal corresponding to a count value of the counter.

A voltage level of the signal line to be varied by each of the plurality of analog arithmetic circuits by the second processing may be determined by the third digital signal.

### BRIEF DESCRIPTION OF DRAWINGS

FIG. 1 A block diagram showing a first example of an arithmetic apparatus according to a first embodiment of the present disclosure.

FIG. 2A A block diagram showing a first configuration example of a capacitance selection unit according to the first embodiment of the present disclosure.

FIG. 2B A circuit diagram showing a configuration of an inverter according to the first embodiment of the present disclosure.

FIG. 2C A block diagram showing a second configuration example of the capacitance selection unit according to the first embodiment of the present disclosure.

FIG. 3 A block diagram showing a second example of the arithmetic apparatus according to the first embodiment of the present disclosure.

FIG. 4A A diagram showing a first configuration example of the arithmetic apparatus shown in FIG. 3.

FIG. 4B A diagram showing a second configuration example of the arithmetic apparatus shown in FIG. 3.

FIG. 5A A block diagram showing a configuration of a signal processing apparatus according to the first embodiment of the present disclosure.

FIG. 5B A schematic diagram showing a first modified example of a logic substrate.

FIG. 5C A schematic diagram showing a second modified example of the logic substrate.

FIG. 6 A block diagram showing a configuration of an arithmetic apparatus according to a comparative example.

FIG. 7 A block diagram showing a configuration of a multiplier according to a comparative example.

FIG. 8 A block diagram showing a configuration of a capacitance selection unit according to a second embodiment of the present disclosure.

FIG. 9 A block diagram of a signal processing circuit according to a third embodiment of the present disclosure.

FIG. 10 A diagram showing a more detailed configuration of the signal processing circuit.

FIG. 11 A circuit diagram showing a specific configuration of a DAC according to the third embodiment of the present disclosure.

FIG. 12 A diagram illustrating first processing according to the third embodiment of the present disclosure.

FIG. 13 A timing chart showing operations of the DAC in the first processing.

FIG. 14 Diagrams showing modified examples of a first capacitor according to the third embodiment of the present disclosure.

FIG. 15 A circuit diagram showing an internal configuration of a ladder multiplier according to the third embodiment of the present disclosure.

FIG. 16 A circuit diagram of a multiplier having a basic structure.

FIG. 17 A circuit diagram showing a configuration of a multiplexer according to the third embodiment of the present disclosure.

FIG. 18 A timing chart showing operations of the DAC in second processing.

FIG. 19A A diagram showing an output of a product-sum operation result of an analog arithmetic circuit.

FIG. 19B A waveform diagram showing a degree of a voltage drop of a signal line according to a product-sum operation value.

FIG. 19C A diagram showing a third analog signal output operation of one analog arithmetic circuit.

FIG. 19D A diagram showing the third analog signal output operation of a plurality of analog arithmetic circuits.

FIG. 19E A waveform diagram showing a state where a voltage of the signal line rises stepwise.

FIG. 19F A waveform diagram showing a voltage rise of the signal line during gain adjustment.

FIG. 20A A diagram showing a first example of a counter synchronization method.

FIG. 20B A diagram showing a second example of the counter synchronization method.

FIG. 20C A diagram showing a third example of the counter synchronization method.

FIG. 20D A diagram showing a fourth example of the counter synchronization method.

FIG. 20E A diagram showing a fifth example of the counter synchronization method.

FIG. 20F A diagram showing a sixth example of the counter synchronization method.

FIG. 20G A diagram showing a seventh example of the counter synchronization method.

FIG. 21 A block diagram showing a configuration of a storage circuit according to the third embodiment of the present disclosure.

FIG. 22 A flowchart showing overall operations of the signal processing circuit according to the third embodiment of the present disclosure.

FIG. 23 A timing chart showing overall operations of the signal processing circuit according to the third embodiment of the present disclosure.

FIG. 24A A circuit diagram showing a configuration of a storage element.

FIG. 24B A circuit diagram showing a configuration of a comparison circuit.

FIG. 24C A circuit diagram showing a configuration of a comparison bias circuit.

FIG. 24D A circuit diagram showing a configuration of a test circuit.

FIG. 25A A diagram showing a first example of a substrate structure of the signal processing circuit according to the third embodiment of the present disclosure.

FIG. 25B A diagram showing a second example of the substrate structure of the signal processing circuit according to the third embodiment of the present disclosure.

FIG. 26A A plan view of the first example of the signal processing circuit according to the third embodiment of the present disclosure.

FIG. 26B A diagram showing a first example of a circuit structure of a ladder multiplier according to the third embodiment of the present disclosure.

FIG. 26C A planar perspective view showing a first example of a wiring structure of the ladder multiplier according to the third embodiment of the present disclosure.

FIG. 27A A plan view of the second example of the signal processing circuit according to the third embodiment of the present disclosure.

FIG. 27B A diagram showing a second example of the circuit structure of the ladder multiplier according to the third embodiment of the present disclosure.

FIG. 27C A planar perspective view showing a second example of the wiring structure of the ladder multiplier according to the third embodiment of the present disclosure.

FIG. 28A A diagram showing a configuration in which a plurality of array units of the same size are arranged.

FIG. 28B A diagram showing a configuration in which a plurality of array units of different sizes are arranged.

FIG. 29 Diagrams showing a difference between the signal processing circuit according to the third embodiment of the present disclosure and a signal processing circuit according to a comparative example.

FIG. 30 A circuit diagram showing a ladder multiplier according to a fourth embodiment of the present disclosure.

FIG. 31A A planar perspective view showing a first example of a wiring structure of the ladder multiplier according to the fourth embodiment of the present disclosure.

FIG. 31B A planar perspective view showing a second example of the wiring structure of the ladder multiplier according to the fourth embodiment of the present disclosure.

FIG. 32 A block diagram showing an example of a schematic configuration of a vehicle control system.

FIG. 33 An explanatory diagram showing an example of installation positions of an outside-of-vehicle information detection unit and an image pickup unit.

### MODES FOR CARRYING OUT THE INVENTION

Hereinafter, embodiments of an arithmetic apparatus, a signal processing apparatus, and a signal processing circuit will be described with reference to the drawings. Descriptions below will mainly be given on main component portions of the arithmetic apparatus, the signal processing apparatus, and the signal processing circuit, but the arithmetic apparatus, the signal processing apparatus, and the signal processing circuit may include component portions and functions that are not shown or described. The descriptions below do not exclude the component portions and functions that are not shown or described.

### First Embodiment

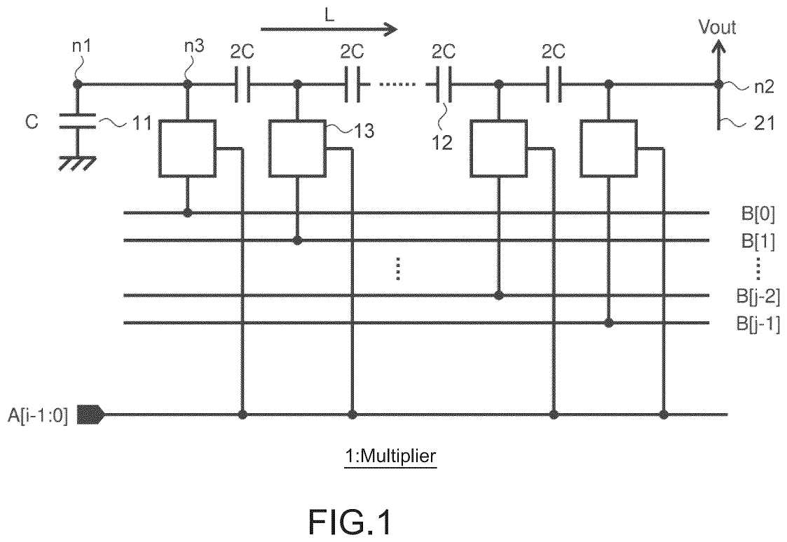

FIG. 1 is a block diagram showing a first example of an arithmetic apparatus according to a first embodiment of the present disclosure. The arithmetic apparatus shown in FIG. 1 is a multiplier and will thus be hereinafter referred to as a multiplier 1. A first digital signal A constituted of a plurality of bits and a second digital signal B constituted of a plurality of bits are input to the multiplier 1. The multiplier 1 multiplies the first digital signal A and the second digital signal B, and outputs the result as a voltage Vout. More precisely, with an output of a charge of the multiplication result, this voltage is output as the voltage Vout by a parasitic capacitance by wiring, and/or the like. FIG. 1 shows an example in which the first digital signal A is constituted of i bits (A[0] to A[i−1]), and the second digital signal B is constituted of j bits (B[0] to B[j−1]).

The multiplier 1 includes a first capacitor 11, a plurality of second capacitors 12, and a plurality of capacitance selection units 13.

The first capacitor 11 is connected between a first node n1 of a signal path L and a reference voltage (e.g., ground voltage) node. The signal path L extends from the first node n1 to a second node n2, which is an output node of the multiplier 1. The first capacitor 11 has a predetermined unit capacitance (e.g., C).

The plurality of second capacitors 12 are connected in series to the signal path L between the first node n1 and the second node n2. The plurality of second capacitors 12 all have the same capacitance value. More specifically, the plurality of second capacitors 12 each have a capacitance value that is twice a capacitance value of the first capacitor 11 (e.g., 2C). In the present specification, of the plurality of second capacitors 12, the second capacitor 12 adjacent to the first capacitor 11 (and the first node n1) will be referred to as a first-stage second capacitor 12, and the second capacitor 12 adjacent to the second node n2 will be referred to as a last-stage second capacitor 12. The voltage Vout, which is a multiplication result of the first digital signal A and the second digital signal B, is output to a signal wiring 21 from the second node n2, which is one end of the last-stage second capacitor 12.

The plurality of capacitance selection units 13 have one ends connected to connection nodes n3 of the first capacitor 11 and the plurality of second capacitors 12. More specifically, the connection nodes n3 are respectively arranged between the first node n1 and the first-stage second capacitor 12, between two adjacent second capacitors 12, and between the second node n2 and the last-stage second capacitor 12.

A voltage corresponding to a corresponding bit value of the second digital signal B is input to the other end of each of the plurality of capacitance selection units 13. For example, a voltage corresponding to a least significant bit (LSB: Least Significant Bit) B[0] of the second digital signal B is input to the other end of the capacitance selection unit 13 having one end connected to the connection node n3 between the first capacitor 11 and the first-stage second capacitor 12. In addition, a voltage corresponding to a most significant bit (MSB: Most Significant Bit) B[j−1] of the second digital signal B is input to the other end of the capacitance selection unit 13 having one end connected to the connection node n3 between the last-stage second capacitor 12 and the second node n2.

Each of the capacitance selection units 13 includes two or more capacitors (third capacitors). The plurality of capacitance selection units 13 select whether or not to connect one ends of the two or more third capacitors to the connection nodes n3 of the signal path L based on the first digital signal A. More specifically, the same number of third capacitors as the bit count of the first digital signal A are provided.

Further, the same first digital signal A is input to the plurality of capacitance selection units 13. In other words, by a bit value of the same first digital signal A, the two or more third capacitors included in each of the plurality of capacitance selection units 13 are switched as to whether or not to apply a voltage corresponding to the corresponding bit value of the second digital signal B to the other end side of the two or more third capacitors.

A voltage corresponding to the multiplication result of the first digital signal A and the second digital signal B is output to the second node n2 of the signal path L. The second node n2 of the signal path L is connected to the signal wiring 21, and the voltage signal corresponding to the multiplication result of the first digital signal A and the second digital signal B is transmitted from the second node n2 to the signal wiring 21.

In FIG. 1, capacitance values of the plurality of capacitors provided in the capacitance selection unit 13 are the same, but a modified example in which the capacitance values of the plurality of capacitors are different from one another is also possible. Hereinafter, a first example and a second example of a specific internal configuration of the capacitance selection unit 13 will be described in order.

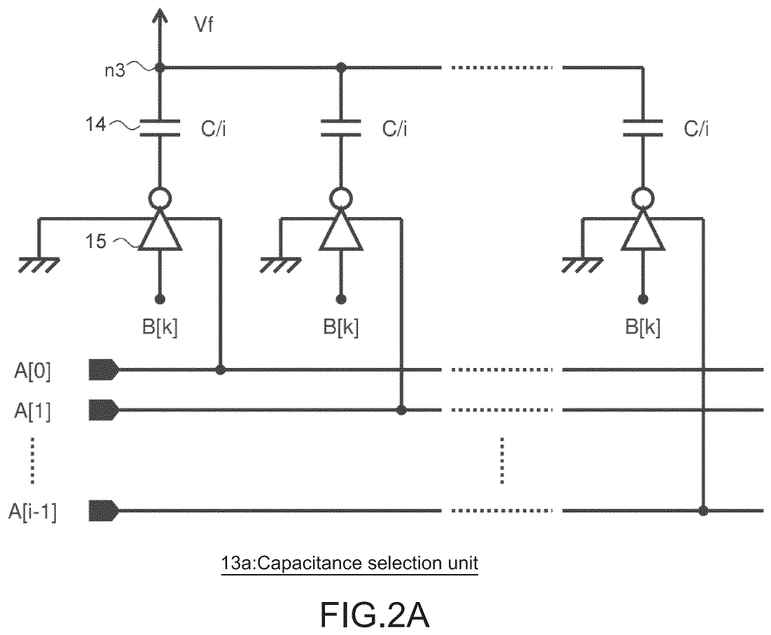

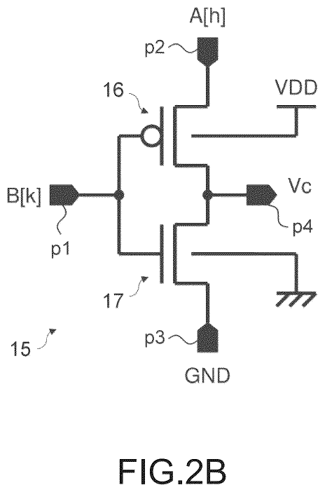

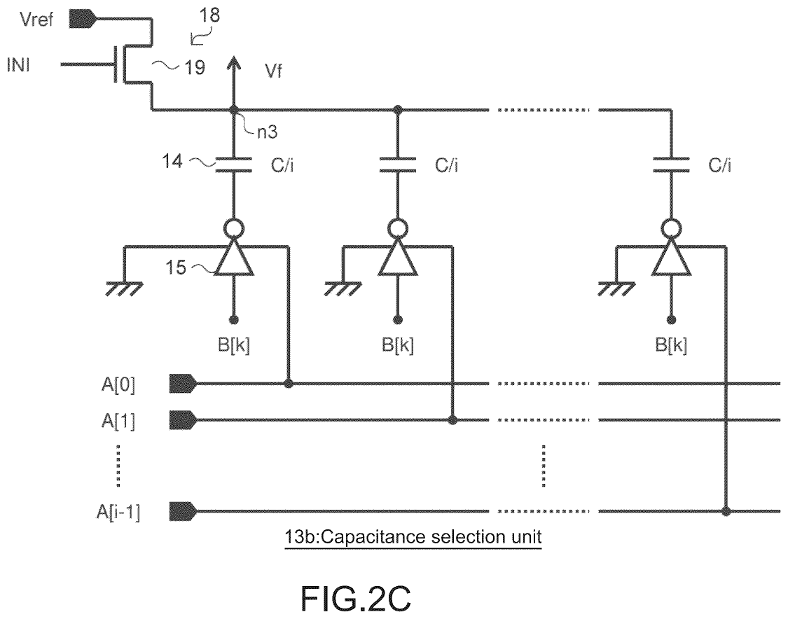

FIG. 2A is a circuit diagram showing the first example of the internal configuration of the capacitance selection unit 13. FIG. 2A shows an internal configuration of a capacitance selection unit 13a of a k+1-th connection node n3 from the left out of the plurality of connection nodes n3 of the signal path L.

As shown in FIG. 2A, the capacitance selection unit 13a according to the first example includes a plurality of third capacitors 14 having one ends connected to the connection nodes n3 of the signal path L and a plurality of inverters 15 connected to the other ends of the plurality of third capacitors 14.

FIG. 2A shows an example in which each of the capacitance selection units 13a includes i (i is an integer of 2 or more) third capacitors 14 and i inverters 15. In this case, the first digital signal A is an i-bit digital signal, and each bit of the first digital signal A is associated with one of the inverters 15. More specifically, a voltage corresponding to each bit value of the first digital signal A is input to a power supply terminal of the corresponding inverter 15. In FIG. 2A, a voltage corresponding to a k+1-th bit value B[k] of the second digital signal B is input to each input terminal of the plurality of inverters 15. An output terminal of the inverter 15 is connected to the third capacitor 14.

FIG. 2B is a circuit diagram showing a configuration of the inverter 15 according to the first embodiment of the present disclosure. The inverter 15 includes transistors 16 and 17. The transistor 16 is, for example, a PMOS (P channel Metal-Oxide-Semiconductor) transistor. The transistor 17 is, for example, an NMOS (N channel Metal-Oxide-Semiconductor) transistor.

The gates of the transistors 16 and 17 are connected to the input terminal p1 of the inverter 15. A voltage corresponding to the bit value B[k] of the second digital signal B is input to the gates of the transistors 16 and 17 by the input terminal p1. The source of the transistor 16 is connected to the power supply terminal p2 of the inverter 15, and a voltage corresponding to any of the bit values of the first digital signal A is input from the power supply terminal p2. In the example shown in FIG. 2B, a voltage corresponding to the h+1-th bit value A[h] of the first digital signal A is input to the source of the transistor 16. A GND (e.g., 0 V) voltage is input to the source of the transistor 16 from the terminal p3. The drains of the transistors 16 and 17 are connected to the output terminal p4. The output terminal p4 outputs a voltage Vc to the third capacitor 14.

For example, when the bit value A[h] is 1, a high voltage is input to the power supply terminal of the inverter 15, and the voltage Vc becomes a voltage corresponding to the bit value B[k]. Conversely, when the bit value A[h] is 0, a low voltage is input to the power supply terminal of the corresponding inverter 15, and the voltage Vc becomes a predetermined reference voltage. In the present specification, a state where the inverter 15 outputs the voltage Vc corresponding to the bit value B[k] is referred to as an enabled state, and a state where the inverter 15 outputs the voltage Vc of a predetermined reference voltage is referred to as a disabled state.

In this manner, by the bit value of the first digital signal A, it is possible to set which of a voltage corresponding to the bit value B[k] and a predetermined reference voltage is to be applied to the third capacitor 14 used by the multiplier 1.

In the present embodiment, the first digital signal A is a thermometer code. The thermometer code is a code in which the number of bits whose bit value becomes 1 increases (or decreases) by one. By setting the first digital signal A to be the thermometer code, the number of third capacitors 14 on the other end side of which a voltage corresponding to the bit value of the second digital signal B is applied out of the plurality of third capacitors 14 can be adjusted arbitrarily.

For example, when the bit count of the first digital signal A is four, four third capacitors 14 are provided. Voltages corresponding to bit values of different bits of the first digital signal A are input to the power supply terminals of the four inverters 15 connected to these four third capacitors 14. Furthermore, a voltage corresponding to the k+1-th bit value of the second digital signal B is input to all of the input terminals of these four inverters 15.

The capacitance of the four third capacitors 14 is ¼ the capacitance value C of the first capacitor 11. Therefore, the combined capacitance of these four third capacitors 14 becomes C. As in this example, two or more third capacitors 14 have the same capacitance value. In addition, a sum of the capacitance values of the two or more third capacitors 14 is equal to the capacitance value of the first capacitor 11.

When the inverter 15 is in the enabled state, the other end of the third capacitor 14 becomes a low voltage (ground voltage) or a high voltage (power supply voltage) according to the k+1-th bit value B[k] of the second digital signal B. A voltage level of the connection node n3 on the one end side of the third capacitor 14 varies depending on which of a low voltage and a high voltage the other end of the third capacitor 14 is. In the capacitance selection unit 13 to which the least significant bit of the second digital signal B is input, this voltage level becomes a value on which the multiplication result of the first digital signal A and the bit value B[0] is reflected. Further, in the capacitance selection unit 13 to which bits other than the least significant bit are input, the voltage level becomes a value obtained by adding the multiplication result of the first digital signal A and the lower bits of the second digital signal B to the multiplication result of the first digital signal A and the bit value B[k].

It is noted that the second digital signal B may be input to the power supply terminal p2 of the inverter 15, and the first digital signal A may be input to the input terminal p1 of the inverter 15. In this case, whether or not all of the inverters 15 in the capacitance selection unit 13a are to be set to the enabled state is switched according to the voltage corresponding to the bit value B[k]. The number of third capacitors 14 to which a high voltage is input is switched according to the respective bits of the first digital signal A. Even in this case, the number of third capacitors 14 on which the voltage of the bit value B[k] is reflected can be adjusted by the first digital signal A.

FIG. 2C is a circuit diagram showing a second example of the internal configuration of the capacitance selection unit 13. As shown in FIG. 2C, a capacitance selection unit 13b according to the second example has a configuration in which a capacitance initialization circuit 18 is further added to the capacitance selection unit 13a shown in FIG. 2A.

The capacitance initialization circuit 18 initializes accumulated capacitances of the plurality of third capacitors 14 before starting a new multiplication in the multiplier 1. The capacitance initialization circuit 18 includes a transistor 19 connected between a reference voltage Vref node and the signal path L. The transistor 19 is, for example, an NMOS transistor. An INI signal is input to the gate of the transistor 19. When the INI signal becomes a high level, the transistor 19 is turned on, and charges corresponding to the reference voltage Vref are accumulated in the plurality of third capacitors 14.

The capacitance initialization circuit 18 may be provided for each of the connection nodes n3 of the signal path L, or one capacitance initialization circuit 18 may be provided with respect to all of the connection nodes n3. The circuit configuration of the capacitance initialization circuit 18 shown in FIG. 2C is a mere example, and the accumulated capacitances of the plurality of third capacitors 14 may be initialized by a circuit configuration different from that shown in FIG. 2C.

As shown in FIGS. 1, 2A, and 2C, the plurality of third capacitors 14 connected to each of the connection nodes n3 in FIG. 1 all have a combined capacitance value of C. As a result, the multiplier 1 shown in FIG. 1 has a C-2C ladder structure in which C (third capacitor 14) is connected between stages of the plurality of 2C (second capacitors 12) connected in series to the signal path L.

When an arbitrary bit of the first digital signal A input to the multiplier 1 shown in FIG. 1 is 1, the inverter 15 corresponding to that bit is set to the enabled state, and a voltage is applied to the corresponding third capacitor 14. In this manner, the first digital signal A is used for the purpose of determining to which other end side of what third capacitor 14 out of the plurality of third capacitors 14 connected to each of the connection nodes n3 of the signal path L a voltage corresponding to the corresponding bit value of the second digital signal B is to be applied. In addition, each bit of the second digital signal B is used for the purpose of setting a voltage of the other end of the plurality of third capacitors 14 connected to the corresponding connection node n3 of the signal path L.

In this manner, the multiplier 1 shown in FIGS. 1, 2A, and 2C multiplies the first digital signal A and the second digital signal B for each of the bits, and outputs the multiplication results to the corresponding connection nodes n3 on the signal path L from the least significant bit to the most significant bit.

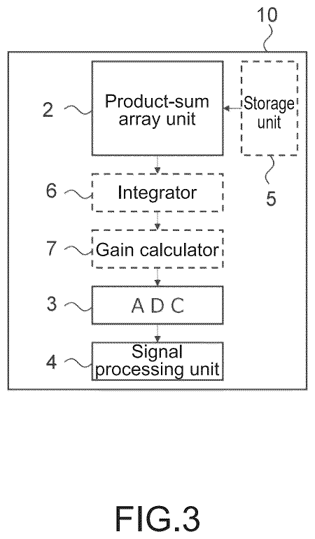

The arithmetic apparatus according to the first embodiment may be configured with a single multiplier 1 shown in FIG. 1, or may have a function of performing a product-sum operation using a plurality of multipliers 1 shown in FIG. 1. FIG. 3 is a block diagram showing a second example of the arithmetic apparatus according to the first embodiment of the present disclosure. The arithmetic apparatus 10 shown in FIG. 3 is characterized in that it includes a plurality of multipliers 1 each having a configuration similar to that shown in FIG. 1 and performs a product-sum operation for adding the multiplication results of the plurality of multipliers 1. More specifically, the arithmetic apparatus 10 includes a product-sum array unit (array unit) 2, an analog-to-digital converter (ADC; Analog to Digital Converter) 3, and a signal processing unit 4.

The product-sum array unit 2 includes the plurality of multipliers 1 arranged in an array. Each of the multipliers 1 has a configuration similar to that shown in FIG. 1. The product-sum array unit 2 performs a product-sum operation for adding the multiplication results of the plurality of multipliers 1. The result of the product-sum operation is transmitted to the analog-to-digital converter 3. The multiplication results of the plurality of multipliers 1 are transmitted through a common output wiring (specifically, the signal wiring 21). Since an output node (specifically, the second node n2) of each of the plurality of multipliers 1 is connected to this output wiring, the plurality of multiplication results are added on the output wiring by a wired addition.

In this manner, by connecting the output nodes of the plurality of multipliers 1 to a common output wiring, the product-sum array unit 2 can perform a sum operation on the output wiring without providing a separate adder.

The product-sum array unit 2 performs a plurality of multiplications in parallel or sequentially using the plurality of multipliers 1. As the number of multipliers 1 provided in the product-sum array unit 2 increases, the number of multiplications that can be performed in parallel or sequentially can be increased, and the speed of the product-sum operation can be increased, but a circuit scale thus becomes large.

The arithmetic apparatus 10 may include a storage unit 5. The storage unit 5 stores one of the first digital signal A or the second digital signal B (for example, first digital signal A). The plurality of multipliers 1 in the product-sum array unit 2 read the first digital signal A from the storage unit 5 and also read the second digital signal B from an external device (for example, sensor). It is noted that the plurality of multipliers 1 may alternatively read both of the first digital signal A and the second digital signal B from the storage unit 5. Alternatively, both of the first digital signal A and the second digital signal B may be read from an external device.

The arithmetic apparatus 10 may include an integrator 6. The integrator 6 is connected to the plurality of multipliers 1, adds or averages the multiplication results of the plurality of multipliers 1, and outputs the result to the analog-to-digital converter 3 as a product-sum operation value.

The arithmetic apparatus 10 may include a gain calculator 7. The gain calculator 7 outputs a value obtained by applying a gain to the multiplication result output from the product-sum array unit 2 or the product-sum operation value output from the integrator 6 and performing a full-scale adjustment, to the analog-to-digital converter 3.

The analog-to-digital converter 3 converts a signal input from the integrator 6 and/or the like into a digital signal, and outputs the digital signal to the signal processing unit 4.

The signal processing unit 4 performs predetermined signal processing based on the digital signal input from the analog-to-digital converter 3. The predetermined signal processing includes, for example, processing for outputting a digital value of 0 or less as 0 by a ReLU (Rectified Linear Unit) operation, and the like. It is noted that the specific signal processing performed by the signal processing unit 4 is arbitrary, and the signal processing unit 4 may be provided separately from the arithmetic apparatus 10. In this case, the internal configuration of the arithmetic apparatus 10 can be simplified.

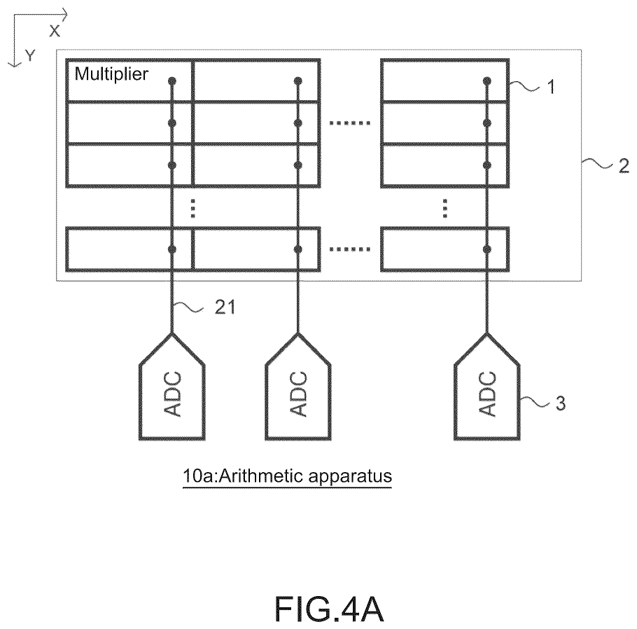

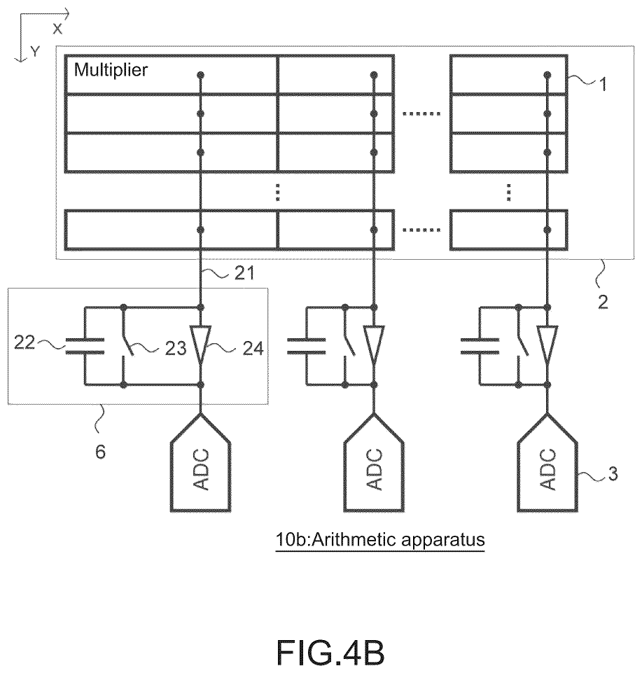

FIG. 4A is a diagram showing a first configuration example of the arithmetic apparatus 10. The arithmetic apparatus 10a shown in FIG. 4A includes the product-sum array unit 2 and a plurality of analog-to-digital converters 3. In FIG. 4A, the illustration of the signal processing unit 4 is omitted. The product-sum array unit 2 includes the plurality of multipliers 1 arrayed in a first direction X and a second direction Y that intersect with each other.

The analog-to-digital converter 3 is arranged for each group of the plurality of multipliers 1 arrayed in the second direction Y. Further, the signal wiring 21 is arranged for each of the analog-to-digital converters 3. The output nodes (second nodes n2) of the plurality of multipliers 1 arrayed in the second direction Y are connected to the signal wiring 21. Accordingly, the multiplication results of the plurality of multipliers 1 are added on the signal wiring 21 so that a product-sum operation result can be obtained. The signal wiring 21 is connected to the input node of the analog-to-digital converter 3. The analog-to-digital converter 3 converts the voltage on the signal wiring 21 (specifically, the voltage Vout generated as a result of adding the charges output by the plurality of multipliers 1) into a digital signal.

To each group of the plurality of multipliers 1 arrayed in the second direction Y, the same first digital signal A may be input from the storage unit 5 not shown in FIG. 4A.

FIG. 4B is a diagram showing a second configuration example of the arithmetic apparatus 10. The arithmetic apparatus 10b shown in FIG. 4B differs from the arithmetic apparatus 10a in the point of including a plurality of integrators 6.

FIG. 4A has shown the example in which the multiplication results of the plurality of multipliers 1 are added on the signal wiring 21 of the product-sum array unit 2, but in FIG. 4B, the multiplication results of the plurality of multipliers 1 are added in the integrator 6 instead of on the signal wiring 21. One integrator 6 is provided for each signal wiring 21. Further, the integrator 6 adds the voltages on the signal wiring 21 according to charges. More specifically, the plurality of multiplication results are input to the integrator 6 from the multipliers 1 in the product-sum array unit 2, and the integrator 6 outputs the integration result to the analog-to-digital converter 3. The integrator 6 includes a capacitor 22, a switch 23, and an amplifier 24 that are connected in parallel between the product-sum array unit 2 and the analog-to-digital converter 3.

The output voltage of the integrator 6 is determined by a capacitance of the capacitor 22 and a sum of the charges output from the multipliers. The switch 23 is used for initializing the accumulated charges of the capacitor 22 by discharging. When a new multiplication result is input via the signal wiring 21 in a state where the switch 23 in off, a voltage corresponding to an addition result with the last product-sum operation result is output. It is noted that the integrator 6 may perform averaging of the multiplication results.

The analog-to-digital converter 3 shown in FIG. 4B converts the voltage obtained by the addition or averaging by the integrator 6 into a digital signal, and outputs the digital signal to the subsequent signal processing unit 4 and/or the like.

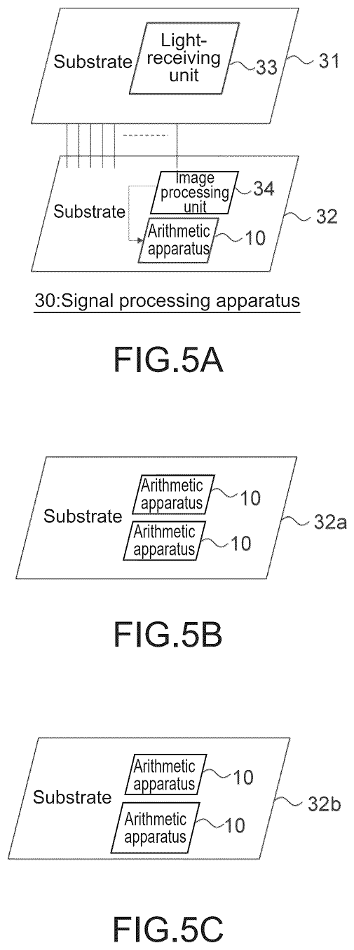

The arithmetic apparatus 10 shown in FIG. 3 can be applied to various applications such as recognition, classification, generation, and/or the like of images, characters, and voices. Hereinafter, as an example, an example in which the arithmetic apparatus 10 shown in FIG. 3 is applied to an image sensor will be described. FIG. 5A is a block diagram showing a configuration of a signal processing apparatus 30 according to the first embodiment of the present disclosure. The signal processing apparatus 30 is, for example, an image sensor, and is used for outputting image data corresponding to luminance of incident light.

The signal processing apparatus 30 has a stacked semiconductor structure in which a substrate 31 and a substrate 32 are stacked. The substrates 31 and 32 are semiconductor substrates each having a semiconductor layer. The substrate 31 includes a light-receiving unit 33. The light-receiving unit 33 receives incident light and outputs a pixel signal corresponding to luminance of the incident light. A part of the light-receiving unit 33 may be arranged on the substrate 32. The substrate 31 is also referred to as a light-receiving substrate.

The substrate 32 includes the arithmetic apparatus 10 and an image processing unit 34. The light-receiving unit 33 and the image processing unit 34 are also collectively referred to as an image pickup unit. The image processing unit 34 performs predetermined signal processing on the pixel signal output from the light-receiving unit 33. The predetermined signal processing includes analog-to-digital conversion for converting the pixel signal into a digital signal. It is noted that the digital signal output from the image processing unit 34 is also referred to as image data. The arithmetic apparatus 10 performs a product-sum operation using the digital signal output from the image processing unit 34. At least one of the first digital signal A or the second digital signal B (for example, second digital signal B) input to the product-sum array unit 2 in the arithmetic apparatus 10 is a digital signal output from the image processing unit 34. The substrate 32 is also referred to as a logic substrate.

The signal processing apparatus 30 shown in FIG. 5A has a two-layer stacked semiconductor structure constituted of the substrates 31 and 32, but the configuration of the signal processing apparatus 30 is not limited to this. For example, the light-receiving unit 33 may be divisionally arranged on a plurality of substrates. In addition, at least one of the image processing unit 34 or the arithmetic apparatus 10 may be divisionally arranged on separate substrates, or the product-sum array unit 2, the analog-to-digital converter 3, and the signal processing unit 4 of the arithmetic apparatus 10 may be divisionally arranged on separate substrates. In other words, the signal processing apparatus 30 may have a structure in which three or more substrates are stacked.

Furthermore, the substrate 32 may include a plurality of arithmetic apparatuses 10. FIG. 5B is a schematic diagram showing a first modified example of the substrate 32. The substrate 32a shown in FIG. 5B is capable of performing two or more different arithmetic processing in parallel by the plurality of arithmetic apparatuses 10. For example, the plurality of arithmetic apparatuses 10 may perform different product-sum operations in parallel, sequentially, or selectively.

Further, the plurality of arithmetic apparatuses 10 may include arithmetic apparatuses 10 having different arithmetic sizes. FIG. 5C is a schematic diagram showing a second modified example of the substrate 32. The substrate 32b shown in FIG. 5C can distinguishably use the plurality of arithmetic apparatuses 10 according to magnitudes of data sizes to be calculated.

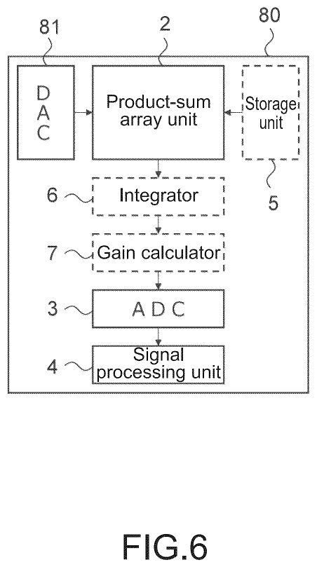

FIG. 6 is a block diagram showing a configuration of an arithmetic apparatus 80 according to a comparative example. The arithmetic apparatus 80 differs from the arithmetic apparatus 10 shown in FIG. 3 in the point of including a digital-to-analog converter (DAC; Digital to Analog Converter) 81. The digital-to-analog converter 81 supplies a voltage Vf obtained by performing digital-to-analog conversion on the first digital signal A to the plurality of multipliers 1 in the product-sum array unit 2.

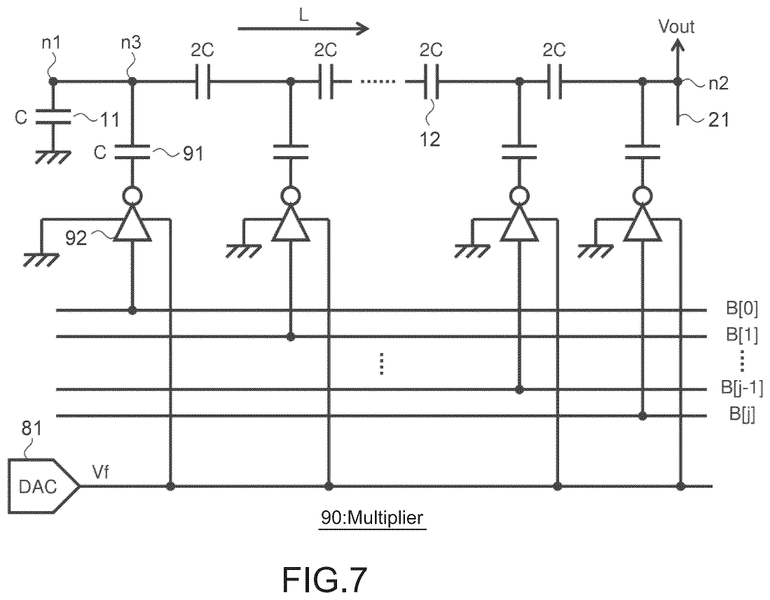

FIG. 7 is a block diagram showing a configuration of a multiplier 90 according to a comparative example. As described above, the voltage Vf from the digital-to-analog converter 81 is input to the multiplier 90 in place of the first digital signal A.

While one ends of the plurality of third capacitors 14 are connected to each of the connection nodes n3 of the signal path L in the multiplier 1 shown in FIG. 1, one end of one third capacitor 14 is connected to each of the connection nodes n3 of the signal path L in the multiplier 90 shown in FIG. 7. The capacitance of the third capacitor 14 is the same as the capacitance of the first capacitor 11 (e.g., C). Therefore, the multiplier 90 shown in FIG. 7 has a C-2C ladder structure similar to the multiplier 1 shown in FIG. 1.

An inverter 92 is arranged for each capacitor 91. The inverter 92 has a structure similar to that of the inverter 15 shown in FIG. 2B. Bits B[0] to B[j−1] are input to the input terminals of the plurality of inverters 92. Thus, the input terminal of each of the inverters 92 becomes a low voltage (for example, ground voltage) or a high voltage (for example, DAC output voltage Vf), and each of the inverters 92 inverts and outputs the voltage of the input terminal. Therefore, the other end of each of the plurality of capacitors 91 is supplied with the DAC output voltage Vf or a low voltage.

Similar to the multiplier 1 shown in FIG. 1, the multiplier 90 shown in FIG. 7 multiplies the first digital signal A and the second digital signal B, and outputs the multiplication result from the second node n2 to the signal wiring 21.

The arithmetic apparatus 80 according to the comparative example converts the first digital signal A into an analog voltage signal by the digital-to-analog converter 81, and inputs the analog signal to the power supply terminals of the plurality of inverters 92. Therefore, the digital-to-analog converter 81 is essential in the arithmetic apparatus 80 according to the comparative example. Since an area of the digital-to-analog converter 81 increases as the bit count of the first digital signal A increases, a circuit area of the multiplier 90 according to the comparative example becomes larger than that of the multiplier 1 shown in FIG. 1, and power consumption also increases.

In contrast, the multiplier 1 according to the first embodiment of the present disclosure can directly input the first digital signal A to the power supply terminals of the plurality of inverters 15 without converting the first digital signal A into an analog voltage signal. Thus, the arithmetic apparatus 10 according to the first embodiment of the present disclosure does not require the digital-to-analog converter 81, and can reduce an area and power consumption as compared to the arithmetic apparatus 80 according to the comparative example.

In this manner, in the multiplier 1 according to the first embodiment of the present disclosure, the first capacitor 11 is connected between the first node of the signal path L and the reference voltage (for example, ground node), the plurality of second capacitors 12 are connected in series between the first node n1 and the second node n2, one end of each of the plurality of third capacitors 14 is connected to each of the connection nodes n3 of the signal path L, and the first digital signal A for switching whether or not to apply a voltage corresponding to the second digital signal B or a predetermined reference voltage to the other ends of the plurality of third capacitors 14 and the second digital signal B to be input to the other ends of the plurality of third capacitors 14 are provided. Therefore, a voltage corresponding to the multiplication result of the first digital signal A and the second digital signal B can be output from the second node n2. Accordingly, it becomes unnecessary to provide a digital-to-analog converter circuit for converting the first digital signal A into an analog signal, and the area and power consumption of the multiplier 1 can be reduced.

### Second Embodiment

The internal configuration of the capacitance selection unit 13 shown in FIG. 1 is not necessarily limited to the circuit configuration shown in FIG. 2A or 2C, and various modified examples are conceivable.

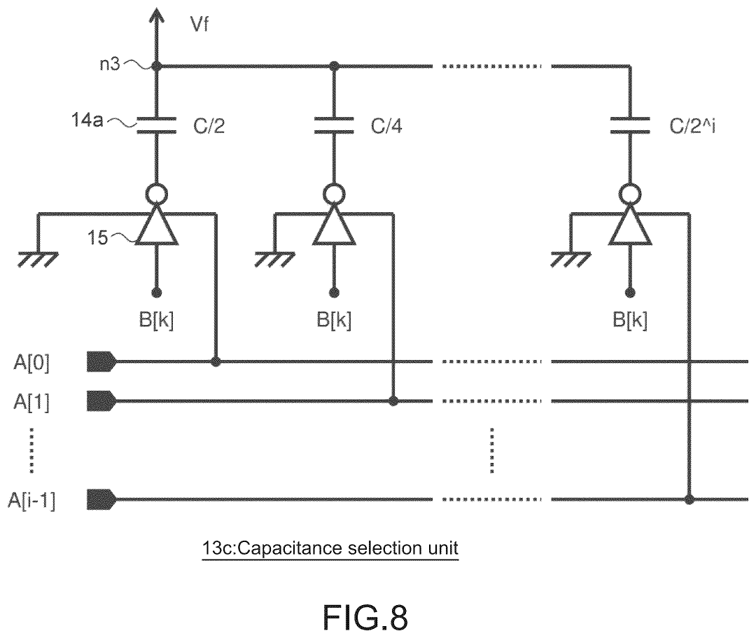

FIG. 8 is a circuit diagram showing an internal configuration of a capacitance selection unit 13c of an arithmetic apparatus according to a second embodiment.

Similar to FIG. 2A, the capacitance selection unit 13c shown in FIG. 8 includes a plurality of third capacitors 14a having one ends connected to the connection nodes n3 of the signal path L, and a plurality of inverters 15 connected to the other ends of the plurality of third capacitors 14a. A difference between the capacitance selection unit 13c shown in FIG. 8 and the capacitance selection unit 13c shown in FIG. 2A is that the plurality of third capacitors 14a in FIG. 8 have mutually-different capacitance values that each are one over a power of two of the capacitance value C of the first capacitor 11.

The capacitance selection unit 13c shown in FIG. 8 can switch the voltage level of the voltage Vf more finely than the capacitance selection unit 13a shown in FIG. 2A. Specifically, when the bit count of the first digital signal A is i, the capacitance selection unit 13a shown in FIG. 2A can output voltages Vf of i different voltage levels. On the other hand, the capacitance selection unit 13c shown in FIG. 8 can output voltages Vf of two to the power of i different voltage levels.

In the first embodiment, it has been necessary to convert the first digital signal A into a thermometer code, but in the second embodiment, it is not necessary to convert the first digital signal A into a thermometer code, and an arbitrary bit string signal can be used as the first digital signal A. This removes the restrictions on the first digital signal A. Therefore, in the second embodiment, the voltage level of the voltage Vf can be switched more finely, and arithmetic performance of the arithmetic apparatus can be improved.

### Third Embodiment

In a third embodiment of the present disclosure, a signal processing circuit capable of performing multibit product-sum operations while saving an area and power consumption with a configuration different from that of the arithmetic apparatus 10 shown in FIG. 3 and the like will be described.

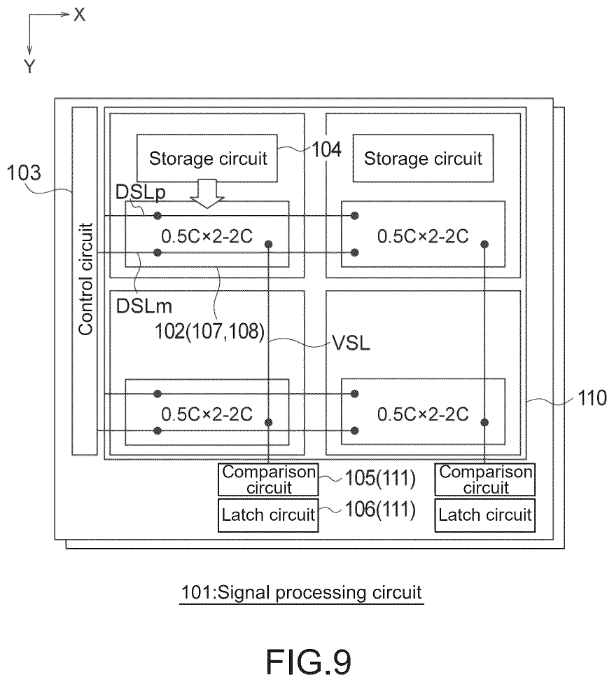

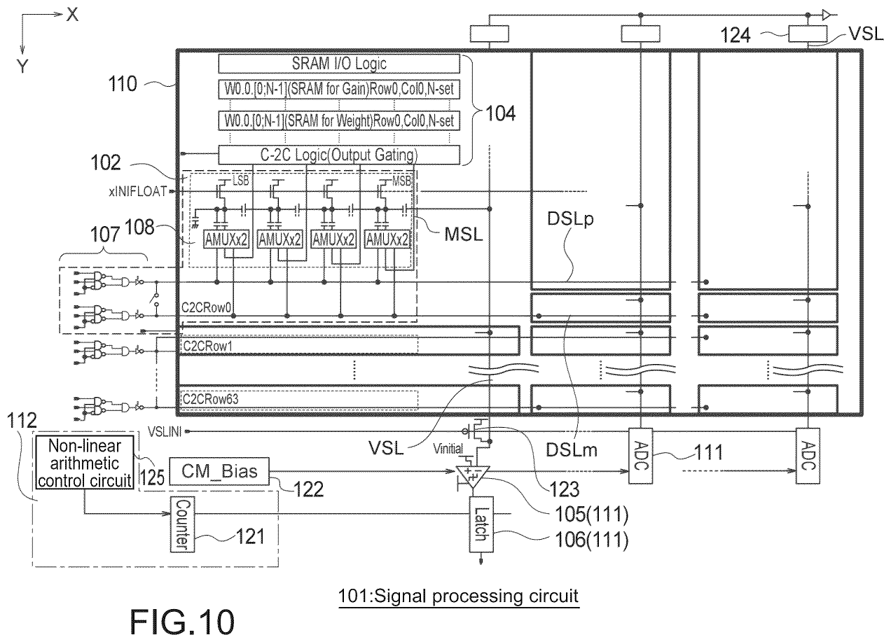

FIG. 9 is a block diagram of a signal processing circuit (signal processing apparatus) 101 according to the third embodiment of the present disclosure. FIG. 10 is a diagram showing a more detailed configuration of the signal processing circuit 101. The signal processing circuit 101 shown in FIG. 9 performs analog product-sum operations and is used in a neural network and/or the like. The signal processing circuit 101 includes an array unit 110 including a plurality of analog arithmetic circuits 102, a control circuit 103, a storage circuit 104, and a plurality of analog-to-digital converters (hereinafter, will be abbreviated to ADCs) 111.

Each of the plurality of analog arithmetic circuits 102 extends in the first direction X of the array unit 110. The plurality of analog arithmetic circuits 102 are arrayed in the second direction Y intersecting with the first direction X. Each of the plurality of analog arithmetic circuits 102 performs a multiplication of the first digital signal and the second digital signal by analog arithmetic processing. More specifically, each of the plurality of analog arithmetic circuits 102 performs first processing for converting the first digital signal into a first analog signal, and also performs second processing for varying a second analog signal corresponding to a multiplied value of the first analog signal obtained by the conversion and the second digital signal based on a third digital signal for setting a gain, to generate a third analog signal. Each of the analog arithmetic circuits 102 includes a digital-to-analog converter (hereinafter, will be abbreviated to DAC) 107 for performing the first processing and a ladder multiplier 108 for performing the second processing.

As will be described later, the DAC 107 performs DA (Digital to Analog) conversion by using some of the capacitors included in the ladder multiplier 108. The ladder multiplier 108 is also used in the processing of the ADC 111. In this manner, by using the ladder multiplier 108 for various purposes, the circuit scale can be reduced.

The ladder multiplier 108 included in each of the plurality of analog arithmetic circuits 102 has a ladder structure in which a plurality of capacitors are connected in series and in parallel. In the present embodiment, since the ladder structure is configured with the plurality of capacitors having two types of capacitances 0.5C and 2C, the analog arithmetic circuit 102 (and the ladder multiplier 108) is expressed as 0.5C×2−2C. A detailed configuration of the analog arithmetic circuit 102 will be described later.

In the present specification, the analog arithmetic circuits 102 arrayed in the first direction X will be referred to as an arithmetic circuit row, and the analog arithmetic circuits 102 arrayed in the second direction Y will be referred to as an arithmetic circuit column. That is, in the array unit 110, a plurality of arithmetic circuit rows each extending in the first direction X are arrayed in the second direction Y. Also in the array unit 110, a plurality of arithmetic circuit columns each extending in the second direction Y are arrayed in the first direction X. The second analog signals indicating multiplication results output from the plurality of analog arithmetic circuits 102 constituting the arithmetic circuit column are each transmitted through the corresponding signal line VSL. The arithmetic circuit rows and arithmetic circuit columns in the array unit 110 can be referred to as a first arithmetic circuit group and a second arithmetic circuit group (or simply as an arithmetic circuit group), respectively.

As described above, each of the plurality of analog arithmetic circuits 102 includes the DAC 107. The DAC 107 converts the first digital signal into the first analog signal. The first digital signal is one of the digital signals used in the multiplication. The DAC 107 outputs the first analog signal obtained by the DA conversion via data lines DSLp and DSLm. It is noted that the plurality of analog arithmetic circuits 102 belonging to different arithmetic circuit columns may share a single DAC 107.

The control circuit 103 controls the plurality of analog arithmetic circuits 102. Specifically, the control circuit 103 inputs various signals including the first digital signal to the DAC 107 in the analog arithmetic circuit 102, to cause the DAC 107 and the ladder multiplier 108 to perform the first processing and second processing described above.

The storage circuit 104 is arranged for each of the arithmetic circuit columns, for example. The storage circuit 104 stores the second digital signal used by the plurality of analog arithmetic circuits 102 to perform multiplications, and the third digital signal for setting a gain, that is used to perform the second processing. The storage circuit 104 supplies the second digital signal and the third digital signal to the plurality of analog arithmetic circuits 102 arrayed in the column direction via a transmission line MSL shown in FIG. 10. The second digital signal is, for example, a weight coefficient by which the first digital signal is multiplied. It is noted that the second digital signal is not necessarily limited to a weight coefficient. The second digital signal is an arbitrary digital signal by which the first digital signal is multiplied. It is noted that the storage circuit 104 may store different second digital signals and third digital signals for the plurality of analog arithmetic circuits 102 arrayed in the column direction. That is, the analog arithmetic circuits 102 provided in the array unit 110 may perform the product-sum operations using different second digital signals and third digital signals. In this case, the storage circuit 104 may be provided separately for each of the analog arithmetic circuits 102.

Each of the plurality of ADCs 111 includes a comparison circuit 105 and a latch circuit 106. Each of the plurality of ADCs 111 is arranged for each of the arithmetic circuit columns. The second analog signals indicating the multiplication results calculated by the plurality of analog arithmetic circuits 102 in the arithmetic circuit column are input to the corresponding ADC 111 via the corresponding signal line VSL. The ADC 111 performs AD (Analog to Digital) conversion to convert the second analog signal transmitted through the corresponding signal line VSL into a fourth digital signal.

The DACs 107 in the plurality of analog arithmetic circuits 102 perform the first processing in parallel to convert the corresponding first digital signal into the first analog signal. The ladder multipliers 108 in the plurality of analog arithmetic circuits 102 multiply the first analog signal and the second digital signal to set the voltage level of the signal line VSL by a second analog signal corresponding to the multiplied value.

The second processing performed by the ladder multiplier 108 includes processing of multiplying the first analog signal and the second digital signal to generate a second analog signal (third processing) and processing of varying the second analog signal based on the third digital signal to generate a third analog signal (fourth processing). In the second processing, the voltage level of the signal line VSL is lowered based on the second analog signal (multiplied value), and then the voltage level of the signal line VSL is raised stepwise based on a gain set by the third digital signal, to generate a fourth analog signal. The comparison circuit 105 determines whether or not the fourth analog signal generated by the second processing has exceeded a predetermined threshold value for each step.

The signal processing circuit 101 includes a counter 121, a comparison bias circuit (CM Bias) 122, a selection switch 123, and a test circuit (monitor circuit) 124 shown in FIG. 10. The counter 121 supplies a count value to the latch circuit 106. The comparison bias circuit 122 supplies a bias signal to the comparison circuit 105. The selection switch 123 switches whether or not to input a voltage of the signal line VSL to the ADC 111. A signal VSLINI is input to the gate of the selection switch 123. The test circuit 124 monitors the voltage level of the signal line VSL to check whether or not an anomaly has occurred in the arithmetic result of the analog arithmetic circuit 102.

The signal processing circuit 101 may include a non-linear calculator 112. The non-linear calculator 112 performs non-linear arithmetic processing on the fourth digital signal output from the ADC 111. A specific example of the non-linear calculator 112 includes the counter 121 described above and a non-linear arithmetic control circuit 125. The non-linear arithmetic control circuit 125 non-linearly controls the count value of the counter 121 according to the value of the fourth digital signal. Details of the processing by the non-linear calculator 112 will be described later.

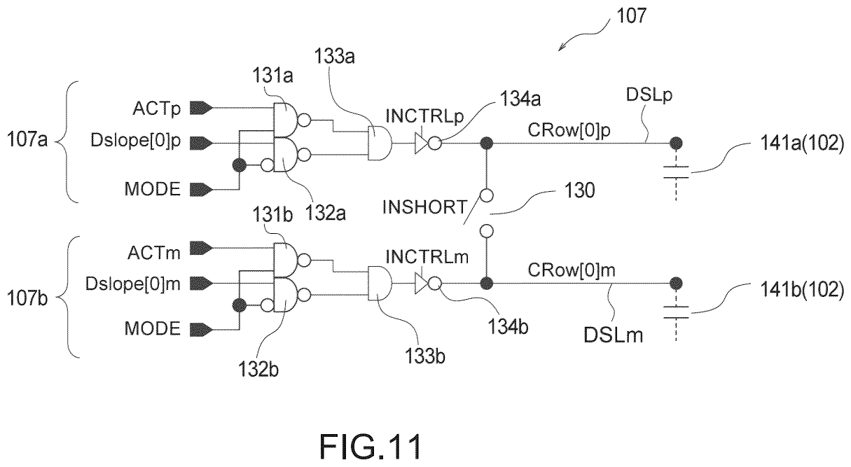

FIG. 11 is a circuit diagram showing a specific configuration of the DAC 107 in the analog arithmetic circuit 102. Two types of first digital signals ACTp and ACTm are input to the DAC 107, but in the present embodiment, the first digital signal ACTm is set to be fixed at a low level, for example. Therefore, in the present specification, ACTp may be referred to as the first digital signal.

The DAC 107 includes a first DAC processing unit 107a, a second DAC processing unit 107b, and a switch 130. The first DAC processing unit 107a generates a first analog signal by performing DA conversion on the first digital signal ACTp, and outputs the first analog signal to the data line DSLp. The data line DSLp is connected to a capacitor 141a in the ladder multiplier 108 via a multiplexer 144 to be described later. For simplification, the multiplexer 144 is omitted in FIG. 11. The second DAC processing unit 107b is connected to the data line DSLm capable of performing a charge redistribution with the data line DSLp, and the data line DSLm is connected to a capacitor 141b in the ladder multiplier 108 via the multiplexer 144 not shown in FIG. 11. The switch 130 is connected between the data lines DSLp and DSLm. The switch 130 is switched on or off by an INSHORT signal. When the switch 130 is turned on, the data lines DSLp and DSLm are short-circuited, the capacitors 141a and 141b are connected in parallel, and charges of the capacitors 141a and 141b are redistributed, so that the data lines DSLp and DSLm are set to have the same voltage. When the switch 130 is turned off, the capacitors 141a and 141b are in a floating state when outputs of inverters 134a and 134b are disabled (invalid), and the capacitors 141a and 141b perform charging or discharging when the outputs are enabled (valid). The data line DSLp becomes a voltage level corresponding to the accumulated charges of the capacitor 141a, and the data line DSLm becomes a voltage level corresponding to the accumulated charges of the capacitor 141b. In the present specification, the capacitors 141a and 141b may each be referred to as the first capacitor.

The first DAC processing unit 107a includes logic circuits 131a, 132a, and 133a and an inverter 134a. The logic circuits 131a, 132a, and 133a each are, for example, an AND circuit. The first digital signal ACTp and a MODE signal are input to the logic circuit 131a. A Dslope[i]p signal and an inverted signal of the MODE signal are input to the logic circuit 132a. The Dslope[i]p signal is a control signal corresponding to the arithmetic circuit row of the row number i. FIG. 11 shows an example in which a Dslope[0]p signal corresponding to the arithmetic circuit row of the row number 0 is input. An inverted signal of the output of the logic circuit 131a and an inverted signal of the output of the logic circuit 132a are input to the logic circuit 133a. The inverter 134a switches the output between enabled (valid) and disabled (invalid) by a logic of an INCTRLp signal. For example, when the INCTRLp signal is of a high level, the inverter 134a outputs an inverted signal of the output signal of the logic circuit 133a.

The signal logic of the MODE signal is switched in a case where the analog arithmetic circuit 102 performs the first processing and a case where the analog arithmetic circuit 102 performs the second processing. For example, when the MODE signal is of a high level, the first DAC processing unit 107a outputs a first analog signal CRow[0]p obtained by performing DA conversion on the first digital signal ACTp. When the MODE signal is of a low level, the first DAC processing unit 107a first outputs the first analog signal CRow[0]p of a low level, and then outputs the first analog signal of a high level at a predetermined timing. As will be described later, when the MODE signal is of a low level, a timing at which the first analog signal CRow[0]p transitions to a high level differs for each of the arithmetic circuit rows.

The second DAC processing unit 107b has a configuration similar to that of the first DAC processing unit 107a. Specifically, the second DAC processing unit 107b includes logic circuits 131b, 132b, and 133b and an inverter 134b. The logic circuits 131b, 132b, and 133b and the inverter 134b correspond to the logic circuits 131a, 132a, and 133a and the inverter 134a of the first DAC processing unit 107a. The first digital signal ACTm and the MODE signal are input to the logic circuit 131b. As described above, in the present embodiment, the first digital signal ACTm is fixed at a low level, for example. A Dslope[i]m signal (Dslope[0]m signal in FIG. 11) and an inverted signal of the MODE signal are input to the logic circuit 132b. The inverter 134b switches whether or not to set the output to the enabled state by an INCTRLm signal corresponding to the INCTRLp signal.

It is noted that the MODE signal and the Dslope[0]p signal may be omitted, and the input signal of the inverter 134a may be generated based on the first digital signal ACTp. In this case, the logic circuits 131a, 132a, and 133a can be omitted. Similarly, the MODE signal and the Dslope[0]m signal may be omitted, and the input signal of the inverter 134b may be generated based on the first digital signal ACTm.

The DAC 107 generates the first analog signals CRow[i]p and CRow[i]m (CRow[0]p and CRow[0]m in FIG. 11) corresponding to the arithmetic circuit row of the row number i, using the first DAC processing unit 107a, the second DAC processing unit 107b, and the switch 130. The first analog signals CRow[0]p and CRow[0]m are supplied to the capacitors 141a and 141b, respectively.

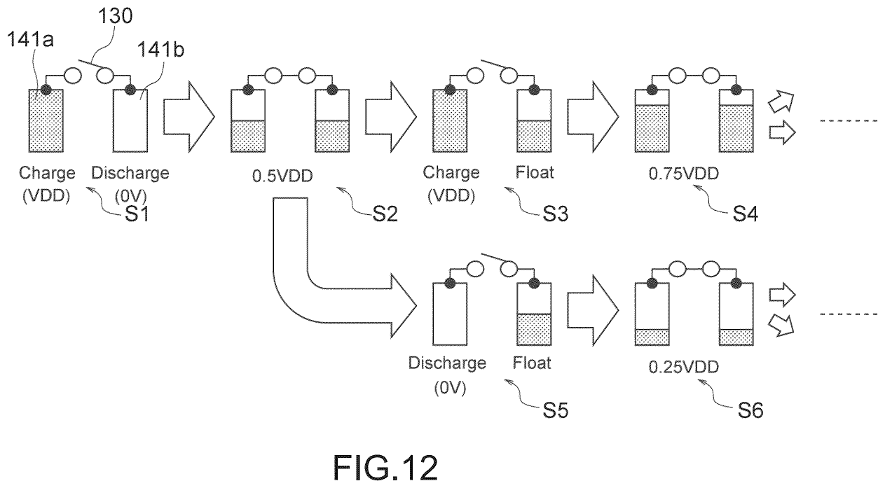

FIG. 12 is a diagram illustrating the first processing according to the third embodiment of the present disclosure. In the first processing, the capacitors 141a and 141b are repeatedly charged/discharged and short-circuited to generate a first analog signal of a signal level obtained by performing DA conversion on the first digital signal.

First, the DAC 107 charges the capacitor 141a and discharges the capacitor 141b in a state where the switch 130 turned off (Step S1). The capacitor 141a is charged to a level of a power supply voltage VDD, for example. The capacitor 141b is discharged to 0 V, for example.

Next, the DAC 107 turns on the switch 130 (Step S2). Accordingly, one ends of the capacitors 141a and 141b are connected to each other, the charged amounts of the capacitors 141a and 141b become the same due to the charge redistribution, and the one ends of the capacitors 141a and 141b connected to the output node of the DAC 107 become 0.5 VDD.

The inverter 134a of the first DAC processing unit 107a outputs a signal having a signal logic corresponding to the signal logic of the first digital signal ACTp, or is set to a floating state. The capacitor 141a performs charging when the output signal of the inverter 134a is of a high level, and performs discharging when the output signal of the inverter 134a is of a low level. Further, the output of the inverter 134b of the second DAC processing unit 107b is continually in the floating state after temporarily becoming the low level. Therefore, in the present embodiment, while the capacitor 141b may perform the discharging operation, the capacitor 141b does not perform the charging operation. The switch 130 is periodically turned on during a period in which the analog arithmetic circuit 102 performs the second processing, and performs the charge redistribution of the capacitors 141a and 141b.

After Step S2, when the first digital signal ACTp becomes a high level, the capacitor 141a performs the charging operation, and the capacitor 141b is set to the floating state (Step S3). After that, the switch 130 is turned on, and the capacitors 141a and 141b perform the charge redistribution so that the voltage level at one ends of the capacitors 141a and 141b becomes 0.75 VDD (Step S4).

Meanwhile, after Step S2, when the first digital signal ACTp becomes a low level, the capacitor 141a performs the discharging operation, and the capacitor 141b is set to the floating state (Step S5). After that, the switch 130 is turned on, and the capacitors 141a and 141b perform the charge redistribution so that the voltage level at one ends of the capacitors 141a and 141b becomes 0.25 VDD (Step S6).

The first digital signal ACTp is constituted of a plurality of bits, and the plurality of bits are input to the logic circuit 131a sequentially from the least significant bit side, for example, so that the charging and discharging operations of the capacitor 141a are performed. When the first digital signal ACTp is eventually processed up to the most significant bit, the first analog signals CRow[i]p and CRow[i]m obtained by performing DA conversion on the first digital signal ACTp are output from one ends of the capacitors 141a and 141b, which are output nodes of the DAC 107.

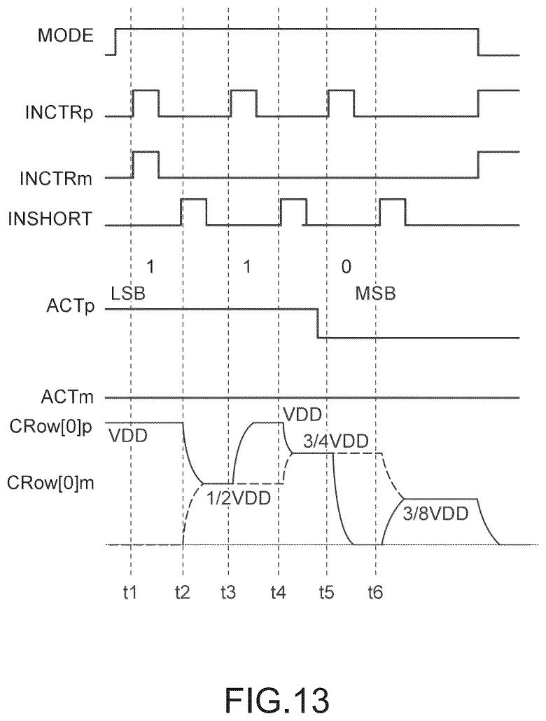

FIG. 13 is a timing chart showing operations of the DAC 107 in the first processing. FIG. 13 shows timings of the MODE signal, the INCTRLp signal, the INCTRLm signal, the INSHORT signal, the first digital signals ACTp and ACTm, and the first analog signals CRow[0]p and CRow[0]m. In the first processing, the MODE signal is set to a high level.

The first digital signal ACTp is a digital signal constituted of a plurality of bits, and the plurality of bits are input to the first DAC processing unit 107a sequentially from the least significant bit. In the example shown in FIG. 13, the first digital signal ACTp is “011”. At a time t1, a least significant bit “1” of the first digital signal ACTp is input, and the INCTRLp signal and the INCTRLm signal transition to a high level. As described above, the first digital signal ACTm is fixed at a low level. Accordingly, the capacitor 141a performs charging, and the capacitor 141b performs discharging. As a result, one end of the capacitor 141a, which is the output node of the first DAC processing unit 107a (i.e., first analog signal CRow[0]p), becomes VDD, and one end of the capacitor 141b, which is the output node of the second DAC processing unit 107b (i.e., first analog signal CRow[0]m), becomes 0 V.

At a time t2, the INSHORT signal transitions to a high level, and the switch 130 is turned on. Accordingly, similar to Step S2 in FIG. 12, the charges of the capacitors 141a and 141b are redistributed, and one ends of the capacitors 141a and 141b become ½ VDD.

At a time t3, the second bit of the first digital signal ACTp is “1”, and the INCTRLp signal is set to a high level. Accordingly, similar to the time t1, the capacitor 141a performs charging. As a result, one end of the capacitor 141a becomes VDD. At this time, the INCTRLm signal is of a low level, and the output of the inverter 134b is set to the floating state. Therefore, the capacitor 141b does not perform charging/discharging and retains the charges, and thus one end of the capacitor 141b remains at ½ VDD. It is noted that after that, the inverter 134b is continually in the floating state during the period of the first processing.

At a time t4, the INSHORT signal is set to a high level, the switch 130 is turned on, and the charges of the capacitors 141a and 141b are redistributed. As a result, one ends of the capacitors 141a and 141b become ¾ VDD.

At a time t5, a most significant bit “0” of the first digital signal ACTp is input, and the INCTRLp signal is set to a high level. Accordingly, the output of the inverter 134a becomes a low level, and the charge of the capacitor 141a is discharged via the inverter 134a. As a result, one end of the capacitor 141a drops to 0 V. At this time, since the output of the inverter 134b is in the floating state, the charge of the capacitor 141b is retained, and one end of the capacitor 141b remains at ¾ VDD.

At a time t6, the INSHORT signal is set to a high level, the switch 130 is turned on, and the charges of the capacitors 141a and 141b are redistributed. As a result, one ends of the capacitors 141a and 141b become ⅜ VDD.

As shown in FIG. 13, the input of each bit of the first digital signal ACTp and the operation of turning on the switch 130 are performed alternately.

As described above, every time the INSHORT signal is set to a high level, the charges of the two capacitors 141a and 141b are redistributed, and the same amount of charges are accumulated in the two capacitors 141a and 141b, so that the voltage levels of one end of the capacitor 141a and one end of the capacitor 141b become equal. Since the INSHORT signal has been set to the high level three times up to the time t6, the level of the first analog signal CRow[0]p (and CRow[0]m) becomes a multiple of ⅛. Further, charges corresponding to the first digital signal ACTp are stored in the capacitors 141a and 141b. In the example shown in FIG. 13, charges corresponding to “011” are stored so that one ends of the capacitors 141a and 141b become ⅜ VDD.

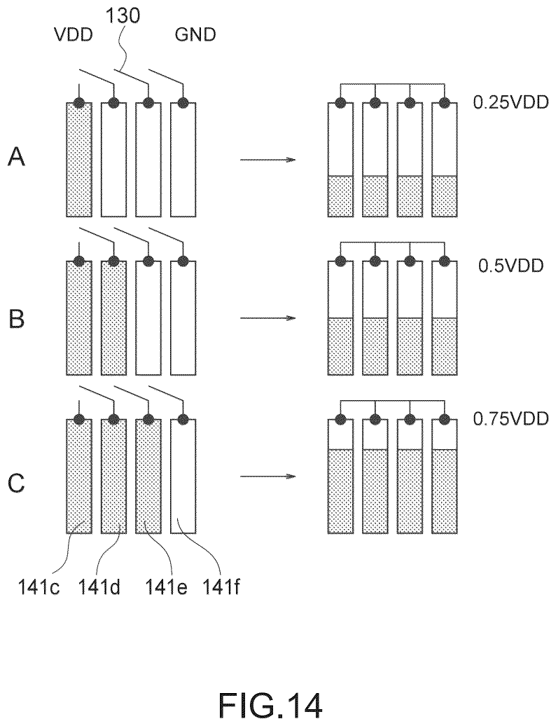

The first capacitor constituted of a plurality of capacitors that perform the charge redistribution may include three or more capacitors. FIG. 14 are diagrams showing modified examples of the first capacitor according to the third embodiment of the present disclosure. FIG. 14 each show an example in which the first capacitor includes four capacitors 141c, 141d, 141e, and 141f. The capacitors 141c to 141e correspond to the capacitor 141a shown in FIG. 12, for example, and the capacitor 141f corresponds to the capacitor 141b, for example. In addition, one end of each of the capacitors 141c to 141f is switched by the switch 130 as to whether or not to be short-circuited.

FIG. 14A shows an example in which the capacitor 141c is in a fully charged state, and the capacitors 141d to 141f are in a fully discharged state. The charging voltage when fully charged is set as VDD. In this state, when one end of each of the capacitors 141c to 141f is short-circuited, the charges are redistributed, and the charging voltages of the capacitors 141c to 141f become 0.25 VDD.

FIG. 14B shows an example in which the capacitors 141c and 141d are in the fully charged state, and the capacitors 141e and 141f are in the fully discharged state. In this state, when one end of each of the capacitors 141c to 141f is short-circuited, the charges are redistributed, and the charging voltages of the capacitors 141c to 141f become 0.5 VDD.

FIG. 14C shows an example in which the capacitors 141c to 141e are in the fully charged state, and the capacitor 141f is in the fully discharged state. In this state, when one end of each of the capacitors 141c to 141f is short-circuited, the charges are redistributed, and the charging voltages of the capacitors 141c to 141f become 0.75 VDD.

In the examples shown in FIGS. 14, the voltage can be switched in units of 0.25 VDD. Further, as in the example of FIG. 13, the charging or discharging and short-circuiting of the capacitors 141c to 141e can be repeated a plurality of times. It is noted that the output of the inverter corresponding to the capacitor 141f is continually in the floating state. Accordingly, high-resolution DA conversion can be performed. By increasing the number of capacitors, the voltage can be switched in smaller units.

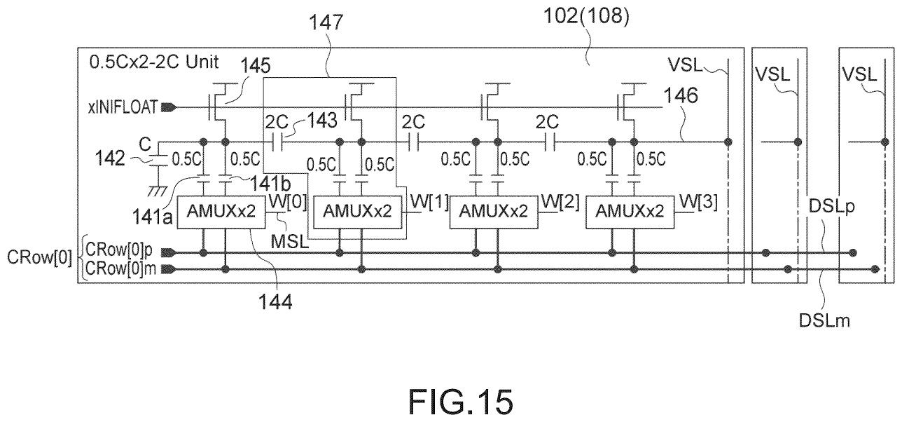

FIG. 15 is a circuit diagram showing an internal configuration of the ladder multiplier 108 in the analog arithmetic circuit 102 according to the third embodiment of the present disclosure. The ladder multiplier 108 includes a plurality of capacitors 141a, a plurality of capacitors 141b, a capacitor 142, a plurality of capacitors 143, a plurality of multiplexers (AMUX: Analog Multiplexer) 144, and a plurality of transistors 145. In the present specification, the plurality of capacitors 143 are also collectively referred to as second capacitors.

The capacitor 142 has a predetermined unit capacitance C, and each of the plurality of capacitors 143 has a capacitance 2C that is twice the capacitance of the capacitor 142. The plurality of capacitors 141a and the plurality of capacitors 141b each have a capacitance 0.5C that is half the capacitance of the capacitor 142. Therefore, the ladder multiplier 108 shown in FIG. 15 can be referred to as a 0.5C×2−2C multiplier.

The ladder multiplier 108 has a ladder structure in which the plurality of capacitors 143 are connected in series to one signal path 146. One end of the signal path 146 is connected to one end of the capacitor 142, and the other end is connected to the signal line VSL. A set of capacitors 141a and 141b are connected between the stages of the plurality of capacitors 143, between the capacitor 143 and the signal line VSL, and between the capacitor 143 and the capacitor 142.

One ends of the plurality of sets of capacitors 141a and 141b are connected to the signal path 146, and the other ends are connected to the corresponding multiplexers 144. A voltage corresponding to a corresponding bit value of the second digital signal W is input to each of the plurality of multiplexers 144. In addition, the first analog signals CRow[0]p and CRow[0]m output from the DAC 107 are input to the plurality of multiplexers 144. The multiplexer 144 switches whether or not to input the first analog signals CRow[0]p and CRow[0]m to the other ends of the corresponding capacitors 141a and 141b based on the corresponding bit value of the second digital signal W. It is noted that hereinafter, the first analog signals CRow[0]p and CRow[0]m may be collectively referred to as a first analog signal CRow[0].

The second digital signal W is input from the storage circuit 104 to the analog arithmetic circuit 102 via the transmission line MSL.

The transistors 145 switch whether or not to perform multiplications in the ladder multiplier 108. The transistors 145 are respectively connected between the stages of the plurality of capacitors 143, between the capacitor 143 and the signal line VSL on the signal path 146, and between the capacitor 143 and the capacitor 142. A xINIFLOAT signal is input to the gate of the transistor 145. In an on state, the transistor 145 initializes the signal path 146 and the signal line VSL to, for example, the power supply voltage VDD. When each of the transistors 145 is in the on state, the ladder multiplier 108 does not perform the multiplication, and the signal line VSL is set to an initial voltage Vinitial.

The ladder multiplier 108 includes a plurality of bit multiplication units 147 each including the capacitors 141a and 141b, the multiplexer 144, the transistor 145, and the capacitor 143 or 142. FIG. 15 shows an example in which the ladder multiplier 108 includes four bit multiplication units 147, but the ladder multiplier 108 can be provided with an arbitrary number of bit multiplication units 147, the arbitrary number being two or more. Voltages corresponding to different bit values of the second digital signal are input to the bit multiplication units 147. In the example of FIG. 15, a least significant bit of the second digital signal is represented by W[0], and a most significant bit is represented by W[3]. A voltage of the least significant bit W[0] is input to the multiplexer 144 on a side closer to the capacitor 142, and a voltage of the most significant bit W[3] is input to the multiplexer 144 on a side closer to the signal line VSL.

The ladder multiplier 108 multiplies the first analog signal CRow[0] and the second digital signal W using the plurality of capacitors 141a, the plurality of capacitors 141b, the capacitor 142, and the plurality of capacitors 143 constituting the plurality of bit multiplication units 147 and the signal path 146.

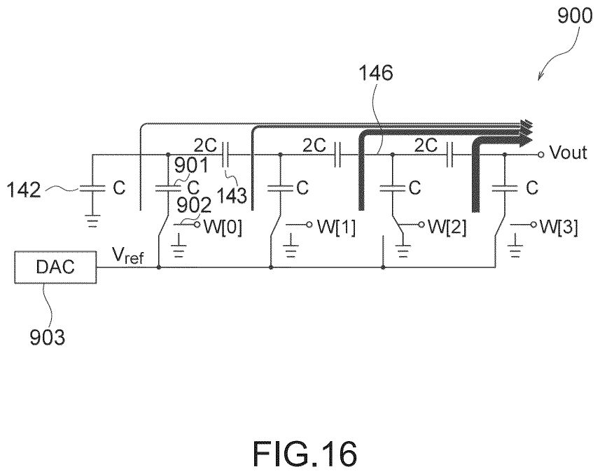

FIG. 16 is a circuit diagram of a multiplier 900 having a basic structure for explaining the operation of the ladder multiplier 108 described above. The multiplier 900 shown in FIG. 16 has a ladder structure obtained by simplifying the ladder multiplier 108 shown in FIG. 15, and includes a plurality of capacitors 901, the capacitor 142, the plurality of capacitors 143, a plurality of switches 902, and the signal path 146. In FIG. 16, the capacitors 141a and 141b shown in FIG. 15 are replaced by one capacitor 901. Also in FIG. 16, the plurality of multiplexers 144 shown in FIG. 15 are replaced by the plurality of switches 902. One ends of the plurality of capacitors 901 are connected to the signal path 146, and the other ends are connected to the corresponding switches 902. The switches 902 make switches as to which of an output line of a DAC 903 and the ground the other ends of the corresponding capacitors 901 are to be connected to. The ladder multiplier 108 shown in FIG. 16 includes the capacitors 901 each having the capacitance C and the capacitors 143 each having the capacitance 2C.

The DAC 903 outputs a first analog signal Vref obtained by performing DA conversion on the first digital signal. The plurality of switches 902 each make a switch between inputting the first analog signal Vref to the other end of the corresponding capacitor 901 and setting the other end to 0 V, according to the corresponding bit value of the second digital signal.

Each of the plurality of capacitors 143 outputs a voltage that is one over a power of two. The output voltage Vout of the multiplier 900 shown in FIG. 16 is expressed by Expression (1) below. In Expression (1), the number of capacitors 901 on the signal path 146 in FIG. 16 is represented by M (M is an integer of 2 or more).

$$[ Expression 1 ]$$

$$Vout = Vref {{\sum }_{k = 0}}^{M - 1} W [ k ] \times {2}^{k - M} \qquad ( 1 )$$

As shown in Expression (1) above, the signal Vout output from the signal path 146 becomes a voltage level corresponding to the multiplication result of the first analog signal Vref and the second digital signal W.

Similar to FIG. 16, the ladder multiplier 108 shown in FIG. 15 outputs a signal expressed by Expression (1) to the signal line VSL. That is, the analog arithmetic circuit 102 shown in FIG. 15 outputs a multiplication result of the first analog signal CRow obtained by performing DA conversion on the first digital signal and the second digital signal W to the signal line VSL.

Since the analog arithmetic circuit 102 according to the third embodiment of the present disclosure has the DAC 107 incorporated therein, it is unnecessary to separately provide a DAC. The DAC 107 has a simple configuration including the switch 130 that redistributes the charges of the capacitors 141a and 141b in the ladder multiplier 108, and can convert the first digital signal into the first analog signal with a circuit scale smaller than that of a normal DAC, and thus the circuit scale can be reduced.

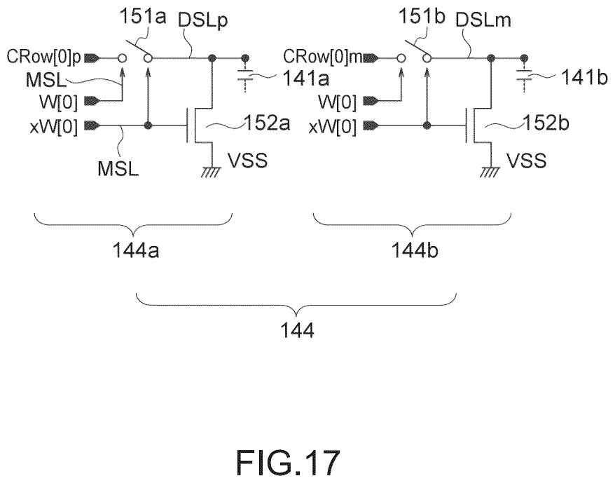

FIG. 17 is a circuit diagram showing a configuration of the multiplexer 144 according to the third embodiment of the present disclosure. The multiplexer 144 is provided in correspondence with the capacitors 141a and 141b. In the case of the ladder multiplier 108 shown in FIG. 15, four multiplexers 144 are provided with respect to the four sets of capacitors 141a and 141b. Each of the multiplexers 144 has a first multiplexer 144a connected to the capacitor 141a and a second multiplexer 144b connected to the capacitor 141b. The first analog signals CRow[0]p and CRow[0]m are input to the first multiplexer 144a and the second multiplexer 144b, respectively.

The first multiplexer 144a includes a switch 151a and a transistor 152a. A voltage corresponding to a corresponding bit of the second digital signal W (W[0] in the example of FIG. 17) is input to one end of the switch 151a. A voltage corresponding to a bit xW[0] obtained by inverting the bit W[0] is input to the other end of the switch 151a. A voltage corresponding to the bit xW[0] is input to the gate of the transistor 152a.

The switch 151a is turned on when the bit W[0] is 1, and inputs the first analog signal CRow[0]p to the other end of the capacitor 141a. The transistor 152a is turned on when the bit W[0] is 0, and connects the other end of the capacitor 141a to the reference voltage VSS node.

The second multiplexer 144b has a structure similar to that of the first multiplexer 144a. The second multiplexer 144b includes a switch 151b and a transistor 152b corresponding to the switch 151a and the transistor 152a, respectively.

It is noted that as shown in FIGS. 14, the capacitors in a number that is a power of two may be provided in place of the capacitors 141a and 141b in the ladder multiplier 108. In this case, the capacitance of each of the capacitors needs to be set to a capacitance that is one over a power of two with respect to the unit capacitance C. That is, each of the plurality of capacitors 143 has a capacitance that is twice or more of the capacitance of the capacitors in the number that is a power of two.

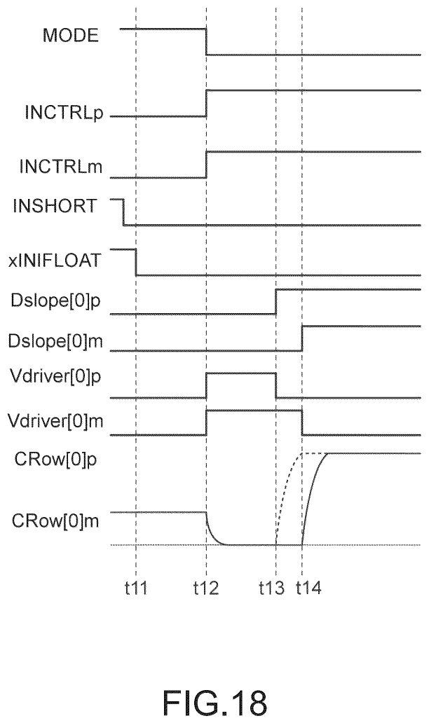

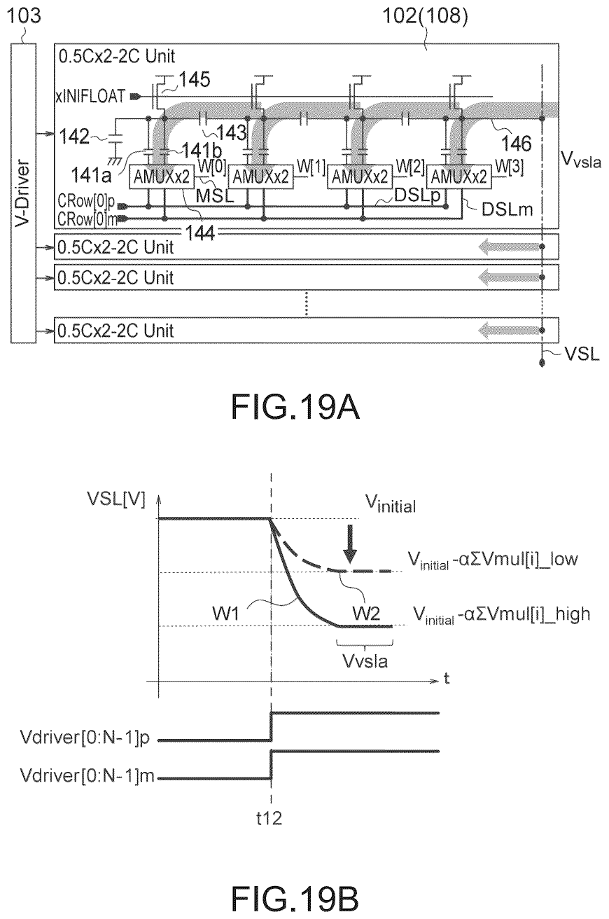

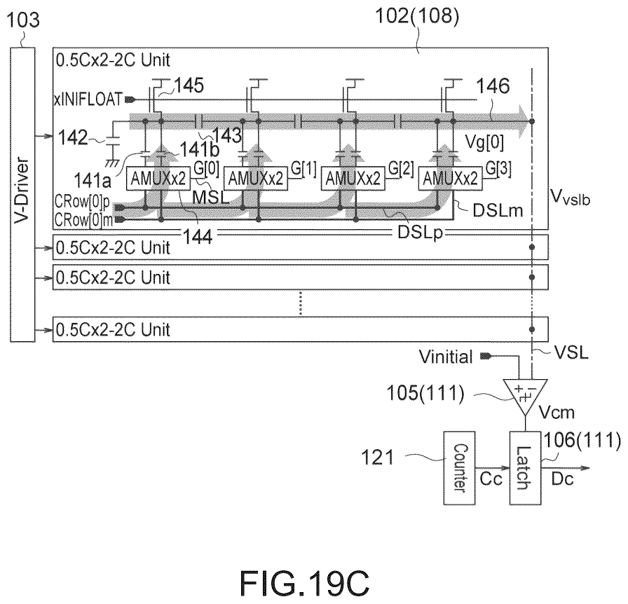

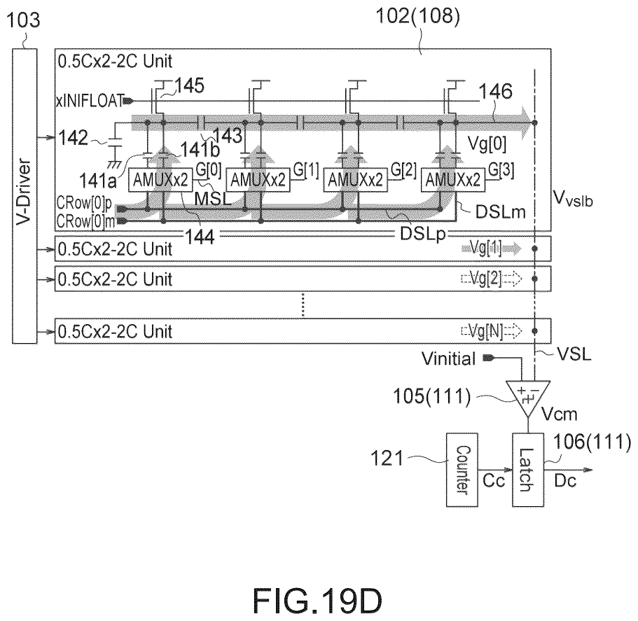

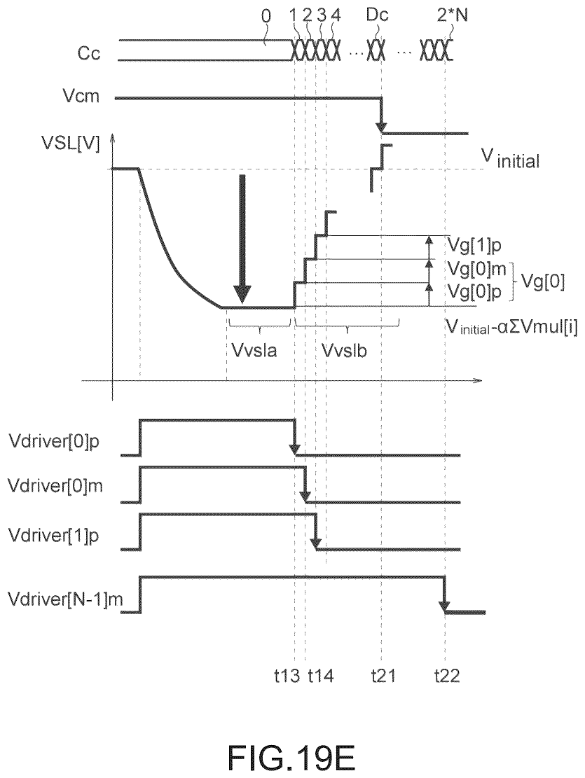

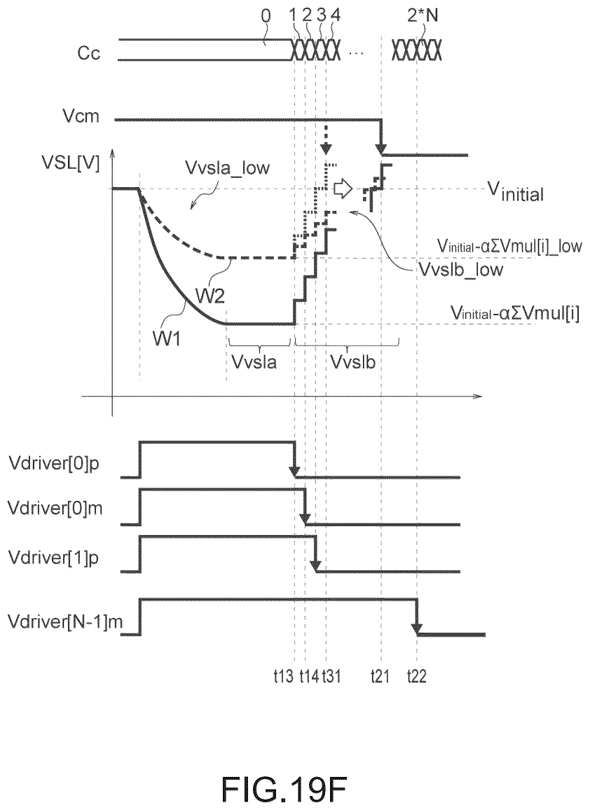

FIG. 18 is a timing chart showing the operations of the DAC 107 in the second processing. FIGS. 19A to 19F are diagrams illustrating the second processing according to the third embodiment of the present disclosure. FIG. 18 shows the timings of the MODE signal, the INCTRLp signal, the INCTRLm signal, the INSHORT signal, the xINIFLOAT signal, the Dslope[0]p signal, the Dslope[0]m signal, the Vdriver[0]p signal, the Vdriver[0]m signal, and the first analog signals CRow[0]p and CRow[0]m. In addition, in the second processing, the INSHORT signal is set to a low level, and the switch 130 is turned off. The Vdriver[0]p signal is a NOR signal of the MODE signal and the Dslope[0]p signal. Similarly, the Vdriver[0]m signal is a NOR signal of the MODE signal and the Dslope[0]m signal.

Before a time t11, the xINIFLOAT signal is of a high level, and the transistors 145 shown in FIG. 15 are turned on, so the signal path 146 and the signal line VSL are initialized to the power supply voltage level.

At the time t11, the xINIFLOAT signal transitions to a low level, and the transistors 145 shown in FIG. 15 are turned off. Accordingly, the analog arithmetic circuit 102 can output a voltage corresponding to the multiplication result to the signal line VSL. During a period from a time before the xINIFLOAT signal becomes a low level to the time t11, the analog arithmetic circuit 102 performs the first processing described above to generate the first analog signals CRow[0]p and CRow[0]m obtained by performing DA conversion on the first digital signal. As shown in FIG. 15, the first analog signals CRow[0]p and CRow[0]m are input to the other ends of the capacitors 141a and 141b via the multiplexer 144. Accordingly, the ladder multiplier 108 can prepare for the multiplication of the first analog signal CRow[0] and the second digital signal W to generate the second analog signal.

At a time t12, the MODE signal is set to a low level, and the INCTRLp signal and the INCTRLm signal are set to a high level. Accordingly, the first analog signals CRow[0]p and CRow[0]m output from the inverters 134a and 134b shown in FIG. 11 become voltage levels corresponding to the logic of the Dslope[0]p signal and the Dslope[0]m signal. At this time point, the Dslope[0]p signal and the Dslope[0]m signal are of a low level, so the voltage levels of the first analog signals CRow[0]p and CRow[0]m drop to a ground level.

FIG. 19A is a diagram showing an operation of the analog arithmetic circuit 102 at the time t12. In the analog arithmetic circuit 102, as the voltage levels of the first analog signals CRow[0]p and CRow[0]m drop, the voltage level of the signal path 146 connected to one ends of the plurality of capacitors 141a and 141b also drops, and further, the voltage level of the signal line VSL connected to the signal path 146 also drops. Since the voltage levels of the first analog signals CRow[0]p and CRow[0]m drop by a voltage value of the first analog signal obtained by the DA conversion right before the time t12, the voltage level of the signal line VSL drops by a voltage width obtained by changing Vref in Expression (1) to (−Vref). That is, the voltage level of the signal line VSL drops from the initial voltage Vinitial by a voltage corresponding to the multiplication result.

As shown in FIGS. 9 and 10, the plurality of analog arithmetic circuits 102 are connected to one signal line VSL, and at the time t12, the plurality of analog arithmetic circuits 102 perform the operation of lowering the voltage level of the signal line VSL in parallel. Accordingly, the signal line VSL becomes a voltage level corresponding to a sum of the multiplication results in all of the analog arithmetic circuits 102, that is, the product-sum operation result. By this operation, the third processing for multiplying the first digital signal converted into the first analog signal Crow and the second digital signal W is performed.

Therefore, the voltage level of the signal line VSL at the time t12 (i.e., second analog signal Vvsla) is expressed by Expression (2) below. In Expression (2), N represents the number of analog arithmetic circuits 102, a represents a voltage deterioration coefficient due to a parasitic capacitance of the signal line VSL, and Vmul[i] represents the output voltage Vout of the signal path 146 of the i-th analog arithmetic circuit 102, and is expressed by Expression (3). In Expression (3), CRow[i] represents the first analog signal obtained by the DA conversion right before the time t12 in the DAC 107 in the i-th analog arithmetic circuit 102, and M represents the number of sets of the capacitors 141a and 141b.

$$[ Expression 2 ]$$

$${V}_{vsla} = {V}_{initial} - α {{\sum }_{i = 0}}^{N - 1} {V}_{mul} [ i ]$$

$${V}_{mul} [ i ] = CRow [ i ] {{\sum }_{k = 0}}^{M - 1} W [ k ] \times {2}^{k - M} .$$

FIG. 19B is a waveform diagram showing a degree of the voltage drop of the signal line VSL corresponding to the product-sum operation value. The vertical axis of FIG. 19B represents the voltage V of the signal line VSL, and the horizontal axis represents the time t. FIG. 19B shows a waveform w1 in a case where the product-sum operation value is large and a waveform w2 in a case where the product-sum operation value is small. As described with reference to FIG. 18, at the time t12, the MODE signal is set to a low level, and the INCTRLp signal and the INCTRLm signal input to the enable terminals of the inverters 134a and 134b are both set to a high level, so the first analog signals CRow[i]p and CRow[i]m output from the inverters 134a and 134b are both set to a low level, and the voltage levels of the signal path 146 and the signal line VSL are lowered by a voltage level corresponding to the multiplication result of the plurality of analog arithmetic circuits 102.

The Vdriver[i]p signal and the Vdriver[i]m signal are signals indicating that the analog arithmetic circuits 102 of the row number i are in the midst of the operation of lowering the voltage level of the signal line VSL. As described above, since the plurality of analog arithmetic circuits 102 lower the voltage level of the signal line VSL in parallel at the time t12, the Vdriver[0:N−1]p signal and the Vdriver[0:N−1]m signal are set to a high level.

At the time t12, the plurality of analog arithmetic circuits 102 lower the voltage level of the corresponding signal path 146 in parallel in accordance with the multiplication results. Therefore, the larger the product-sum operation value that is a sum of the multiplication results of the analog arithmetic circuits 102, the larger the reduction width of the voltage level of the signal line VSL. In the example of FIG. 19B, the voltage level of the signal line VSL is lower in the waveform w1 in which the product-sum operation value of the plurality of analog arithmetic circuits 102 is large than in the waveform w2 in which the product-sum operation value is small. The signal line VSL becomes a voltage lowered by a voltage αΣVmul[i] _high corresponding to the product-sum operation value from the initial voltage Vinitial of the signal line in the waveform w1, and becomes a voltage lowered by a voltage αΣVmul[i] _low corresponding to the product-sum operation value from the initial voltage Vinitial in the waveform w2.

In the present specification, the processing in which the plurality of analog arithmetic circuits 102 simultaneously lower the voltage level of the signal line VSL based on the plurality of first analog signals CRow[i] is also referred to as third processing.

At a time t13 in FIG. 18, the Dslope[0]p signal is set to a high level, and the signal level of the first analog signal CRow[0]p rises. Thus, the voltage level of the signal path 146 of the analog arithmetic circuits 102 of the row number 0 rises by one step, and accordingly, the voltage level of the third analog signal output from the ladder multiplier 108 rises by one step, and the voltage level of the fourth analog signal on the signal line VSL rises by one step. At a time t14, the Dslope[0]m signal is set to a high level, and the signal level of the first analog signal CRow[0]m rises. Thus, the voltage level of the third analog signal output from the ladder multiplier 108 in the analog arithmetic circuits 102 of the row number 0 further rises by one step, and accordingly, the voltage level of the fourth analog signal on the signal line VSL further rises by one step. By sequentially raising the signal levels of the first analog signals CRow[0]p and CRow[0]m corresponding to the analog arithmetic circuits 102 of the row number 0 in this manner, the voltage level of the fourth analog signal on the signal line VSL is raised by two steps. It is noted that it is also possible to set the Dslope[0]m signal to a high level simultaneous with a timing at which the Dslope[0]p signal is set to a high level, and raise the voltage level of the fourth analog signal on the signal line VSL in one step.

FIG. 19C is a diagram showing the operation of the analog arithmetic circuit 102 of the row number 0 at the time t14. It is noted that FIG. 19C (and FIG. 19D to be described later) illustrates an example in which the Dslope[0]p signal and the Dslope[0]m signal are simultaneously set to a high level, and the voltage level of the fourth analog signal on the signal line VSL is raised in one step. In the analog arithmetic circuit 102 of the row number 0, along with the rise of the levels of the first analog signals CRow[0]p and CRow[0]m, the voltage level of the third analog signal Vg[0] output from the ladder multiplier 108 of the row number 0 rises by one step, and accordingly, the voltage level of the fourth analog signal Vvslb on the signal line VSL also rises by one step. The one-step voltage rising width of the third analog signal Vg[0] and the fourth analog signal Vvslb is controlled by the third digital signal G for setting a gain that is input to the multiplexer 144. The third digital signal G has the same bit count as the second digital signal W, and each bit of the third digital signal G is input to the corresponding multiplexer 144 of the ladder multiplier 108. When a bit value of the third digital signal G is 0, the other ends of the corresponding capacitors 141a and 141b are set to 0 V, and when the bit value is 1, the other ends of the corresponding capacitors 141a and 141b become the voltage level of the first analog signals CRow[i]p and CRow[i]m.

As described above, since the voltage levels of the first analog signals CRow[i]p and CRow[i]m become high at the time t14, when the corresponding bit value of the third digital signal G is 1, the voltage level of the third analog signal Vg[0] output from the ladder multiplier 108 rises. On the other hand, when the bit value is 0, the voltage level of the third analog signal Vg[0] is retained.

As described above, the voltage rising width of the third analog signal Vg[0] output from the ladder multiplier 108 and the fourth analog signal Vvslb on the signal line VSL can be adjusted by the bit values of the third digital signal G.

After that, the signal levels of the first analog signals CRow[i]p and CRow[i]m in the i-th analog arithmetic circuit 102 of the first onwards are sequentially raised, thereby increasing the voltage level of the fourth analog signal Vvslb on the signal line VSL one step at a time.

FIG. 19D is a diagram showing the operations of the plurality of analog arithmetic circuits 102 at the time t14 and onwards. As the voltage level of the third analog signal Vg[i] output from the ladder multiplier 108 in the plurality of analog arithmetic circuits 102 rises one step at a time, the voltage level of the fourth analog signal Vvslb on the signal line VSL also increases one step at a time.

As described above, the plurality of analog arithmetic circuits 102 sequentially raise the voltage level of the third analog signal Vg[i] based on the plurality of input third digital signals G. Thus, in the present specification, the processing in which the plurality of analog arithmetic circuits 102 raise the voltage level of the signal line VSL stepwise to generate the fourth analog signal Vvslb will also be referred to as fourth processing.

As shown in FIGS. 19C and 19D, the comparison circuit 105 is connected to the signal line VSL. The comparison circuit 105 compares the voltage level of the fourth analog signal Vvslb on the signal line VSL with the initial voltage Vinitial, and outputs a Vcm signal indicating the comparison result. When the voltage level of the fourth analog signal Vvslb becomes higher than the initial voltage Vinitial, the comparison circuit 105 causes the Vcm signal to transition from a high level to a low level, for example.

The latch circuit 106 latches (retains) a count value Cc indicating a count value of the counter 121 at the timing the Vcm signal transitions from a high level to a low level, and outputs the retained data as a fourth digital signal Dc.

Until the voltage level of the fourth analog signal Vvslb exceeds the initial voltage Vinitial, the comparison circuit 105 outputs a high-level Vcm signal, and the latch circuit 106 does not perform the latch operation. Therefore, the fourth digital signal Dc is not generated until the voltage level of the fourth analog signal Vvslb exceeds the initial voltage Vinitial.

FIG. 19E is a waveform diagram showing a state where the fourth analog signal Vvslb on the signal line VSL obtained by the second processing rises stepwise. The voltage level of the fourth analog signal Vvslb on the signal line VSL rises stepwise by sequentially raising the first analog signals CRow[i]p and CRow[i]m in the plurality of analog arithmetic circuits 102 from a state where the voltage level has been lowered to Vinitial-αΣVmul[i]. As described above, a rising width of the voltage level of the fourth analog signal Vvslb (and the third analog signal Vg[i]) is controlled by the bit values of the third digital signal G. In the present specification, the stepwise rising width of the voltage level of the fourth analog signal Vvslb will be referred to as a gain of the second processing.

For example, as shown in FIG. 18, at the time t13, by the Dslope[0]p signal being set to a high level, the Vdriver[0]p signal is set to a low level, and the voltage level of the fourth analog signal Vvslb on the signal line VSL rises by a voltage width Vg[0]p. After that, at the time t14, the Vdriver[0]m signal is set to a low level, and the voltage level of the fourth analog signal Vvslb on the signal line rises by a voltage width Vg[0]m. Similarly, at the time t13 and the time t14, the voltage level of the third analog signal Vg[0] rises by the voltage widths Vg[0]p and Vg[0]m.

As shown in FIG. 19E, the fourth analog signal Vvslb has a voltage level in which the plurality of third analog signals Vg[i] are added stepwise to the voltage level of the second analog signal Vvsla.

For example, the counter 121 counts up the count value Cc in synchronization with the timings at which the voltage level of the fourth analog signal Vvslb on the signal line VSL rises stepwise.

When the voltage level of the fourth analog signal Vvslb on the signal line VSL reaches the voltage Vinitial at a time t21, the Vcm signal output from the comparison circuit 105 transitions from a high level to a low level, and the latch circuit 106 latches the count value Cc at that time point and outputs the latched count value Cc as the fourth digital signal Dc. After that, although the voltage level of the fourth analog signal Vvslb on the signal line VSL continues to rise stepwise until the first analog signals CRow[i]p and CRow[i]m in all of the analog arithmetic circuits 102 are raised (time t22), the fourth digital signal Dc does not change.

As shown in FIGS. 19C to 19E, the ADC 111 (i.e., the comparison circuit 105 and the latch circuit 106) converts the fourth analog signal Vvslb obtained by the second processing into the fourth digital signal Dc. That is, the ADC 111 can perform AD conversion on the product-sum operation result of the plurality of analog arithmetic circuits 102.

FIG. 19F is a waveform diagram showing a voltage rise of the signal line VSL in a case where the gain of the fourth analog signal Vvslb is adjusted. The gain of the fourth analog signal Vvslb can be adjusted by adjusting each of the bit values of the third digital signal G. For example, when the voltage level of the second analog signal Vvsla (Vvsla low) is Vinitial-αΣVmul[i] low, the level of the fourth analog signal Vvslb (Vvslb_low) reaches the voltage Vinitial at a time t31, which is earlier than the time t21 described above.

By reducing the bit string of the third digital signal G, the voltage rising width of the third analog signal Vg[i] generated by the analog arithmetic circuit 102 can be reduced, and a time when the voltage level of the fourth analog signal Vvslb on the signal line VSL reaches the initial voltage Vinitial can be delayed from the time t31. For example, the time when the voltage level of the fourth analog signal Vvslb_low reaches the voltage Vinitial can be set to the time t21 which is the same as described above.

As a comparative example of the second processing according to the third embodiment of the present disclosure, an example in which a reference signal generation circuit is provided is conceivable. The reference signal generation circuit generates a reference signal that varies with time and inputs the reference signal to the comparison circuit 105. For example, the comparison circuit 105 compares the second analog signal Vvsla with the reference signal, and, at a timing when a voltage level of the reference signal reaches the voltage level of the second analog signal Vvsla, causes the latch circuit 106 to latch the count value Cc to generate the fourth digital signal Dc. This makes it possible to generate the fourth digital signal Dc by performing AD conversion on the product-sum operation result of the plurality of analog arithmetic circuits 102.

Since the reference signal generation circuit is required in the comparative example described above, an area of the signal processing circuit 101 increases. In addition, since the reference signal generation circuit generates a reference signal whose voltage level varies, power consumption also increases. In contrast, in the third embodiment of the present disclosure, since the voltage level of the fourth analog signal Vvslb on the signal line VSL is raised stepwise by sequentially raising the signal levels of the first analog signals CRow[i]p and CRow[i]m in the plurality of analog arithmetic circuits 102, the comparison circuit 105 only needs to compare the voltage level of the fourth analog signal Vvslb with the initial voltage Vinitial, whose voltage level is fixed, and thus the circuit scale can be reduced, and also the power consumption can be suppressed.

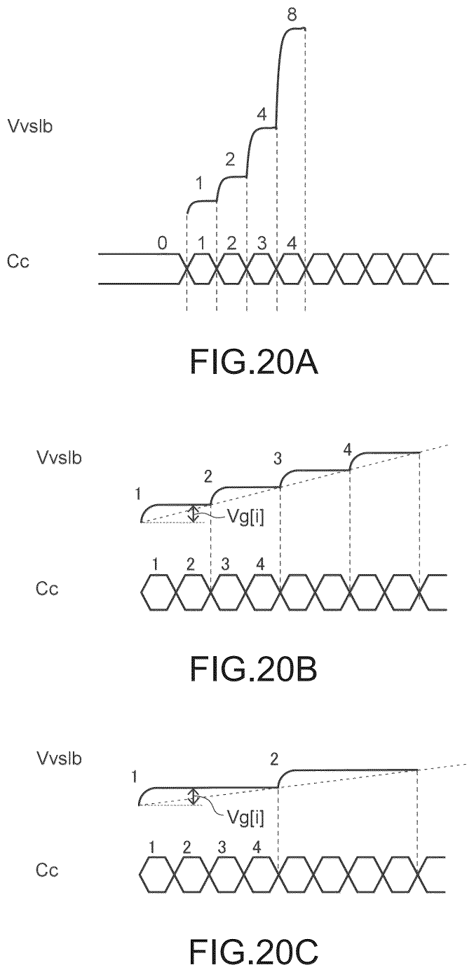

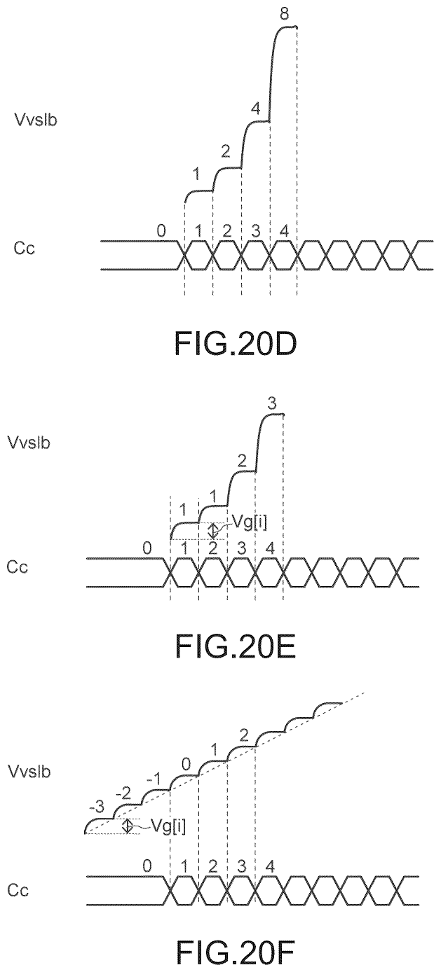

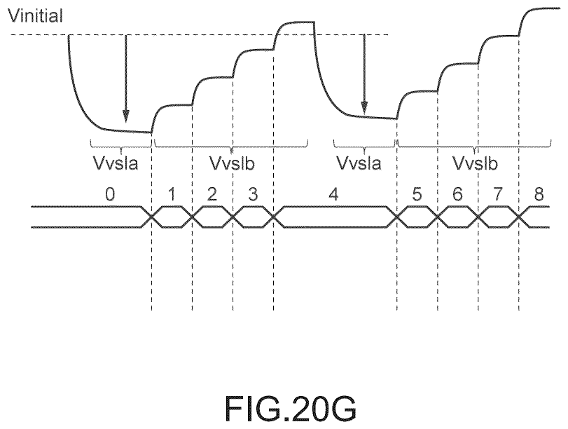

Although the example above has described the case where the count value Cc of the counter 121 is counted up in synchronization with the timings at which the voltage level of the fourth analog signal Vvslb on the signal line VSL rises stepwise, there are a plurality of modified examples regarding the timings at which the count value Cc of the counter 121 is counted up. FIG. 20A is a diagram showing a first example of a synchronization method for the counter 121. The first example is the synchronization method for the counter 121 described in FIG. 19E and the like. In the first example, as shown in FIG. 20A, the count value Cc of the counter 121 is counted up in synchronization with the timings at which the voltage level of the fourth analog signal Vvslb (and the third analog signal Vg[i]) on the signal line VSL rises stepwise.

FIG. 20B is a diagram showing a second example of the synchronization method for the counter 121. FIG. 20C is a diagram showing a third example of the synchronization method for the counter 121. In the second example, as shown in FIG. 20B, the count value Cc of the counter 121 is counted up twice each time the voltage level of the fourth analog signal Vvslb on the signal line VSL rises by one step. That is, a count cycle of the counter 121 in the second example is ½ the cycle at which the voltage level of the fourth analog signal Vvslb rises. In the third example, as shown in FIG. 20C, the count value Cc of the counter 121 is counted up four times each time the voltage level of the fourth analog signal Vvslb on the signal line VSL rises by one step. That is, the count cycle of the counter 121 in the third example is ¼ the cycle at which the voltage level of the fourth analog signal Vvslb rises.

The second and third examples may be generalized so that the count cycle of the counter 121 is set to a power of two or one over a power of two of the cycle at which the voltage level of the fourth analog signal Vvslb rises. According to the second and third examples, the output of the fourth digital signal Dc can be adjusted.

FIGS. 20A to 20C have shown the examples in which the voltage of the fourth analog signal Vvslb on the signal line VSL rises stepwise by the same voltage width, but the voltage width may vary by a power of two or one over a power of two.

FIG. 20D is a diagram showing a fourth example of the synchronization method for the counter 121. In the fourth example, as shown in FIG. 20D, the voltage level of the fourth analog signal Vvslb increases stepwise by a voltage width of a power of two, and the count value Cc of the counter 121 is counted up in accordance with the change in the voltage level of the fourth analog signal Vvslb.

FIG. 20E is a diagram showing a fifth example of the synchronization method for the counter 121. In the fifth example, as shown in FIG. 20F, the voltage level of the fourth analog signal Vvslb on the signal line VSL increases stepwise by a voltage width expressed by the Fibonacci sequence, and the count value Cc of the counter 121 is counted up in accordance with the change in the voltage level of the fourth analog signal Vvslb.

It is also possible to combine the second or third example described above with the fourth or fifth example. Alternatively, a time interval at which the voltage width of the fourth analog signal Vvslb on the signal line VSL varies does not necessarily need to be constant, and the time interval may vary periodically or irregularly.

FIG. 20F is a diagram showing a sixth example of the synchronization method for the counter 121. In the sixth example, as shown in FIG. 20F, the counter 121 starts the count-up operation after a predetermined period has elapsed since a start of the stepwise change of the voltage level of the fourth analog signal Vvslb on the signal line VSL. Alternatively, the counter 121 may perform the count-up operation only when the voltage level of the fourth analog signal Vvslb is within a predetermined voltage range.

In the sixth example, even when the level of the fourth analog signal Vvslb reaches the voltage Vinitial before the count-up operation of the counter 121 is started, the count value Cc to be latched by the latch circuit 106 is 0, and the value of the fourth digital signal Dc is also 0. That is, in the sixth example, a ReLU (Rectified Linear Unit) operation in which 0 is continued to be output before a count-up operation start time can be realized. The ReLU operation may be performed in a stage subsequent to the ADC 111. For example, a non-linear arithmetic circuit that outputs the fourth digital signal Dc as it is if the fourth digital signal Dc is a positive value and outputs 0 if the fourth digital signal Dc is a negative value may be provided subsequent to the ADC 111. It is noted that the sixth example may be combined with at least one of the first to fifth examples described above.

FIG. 20G is a diagram showing a seventh example of the synchronization method for the counter 121. In the first to sixth examples, the voltage level of the signal line VSL has been initialized to the initial voltage Vinitial and the count value Cc of the counter 121 has been initialized every time one product-sum operation ends. However, in the seventh example, as shown in FIG. 20G, even when one product-sum operation ends and the signal line VSL is initialized to the initial voltage Vinitial, the count value of the counter 121 is retained without being initialized. Accordingly, the counter 121 can accumulate a plurality of product-sum operation results and generate a fourth digital signal by the cumulative addition. The seventh example may be combined with at least one of the first to sixth examples described above.

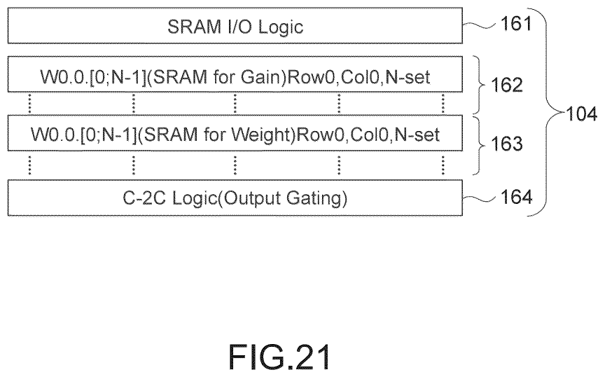

FIG. 21 is a block diagram showing a configuration of the storage circuit 104 according to the third embodiment of the present disclosure. The storage circuit 104 includes, for example, an SRAM (Static Random Access Memory). The storage circuit 104 includes a logic circuit (I/O Logic) 161 that controls the operation of the storage circuit 104, a gain storage circuit (SRAM for Gain) 162 that stores the third digital signal G for each of the analog arithmetic circuits 102, a weight coefficient storage circuit (SRAM for Weight) 163 that stores the second digital signal W for each of the analog arithmetic circuits 102, and an output circuit 164 that outputs the second digital signal W and the third digital signal G to the corresponding analog arithmetic circuit 102.

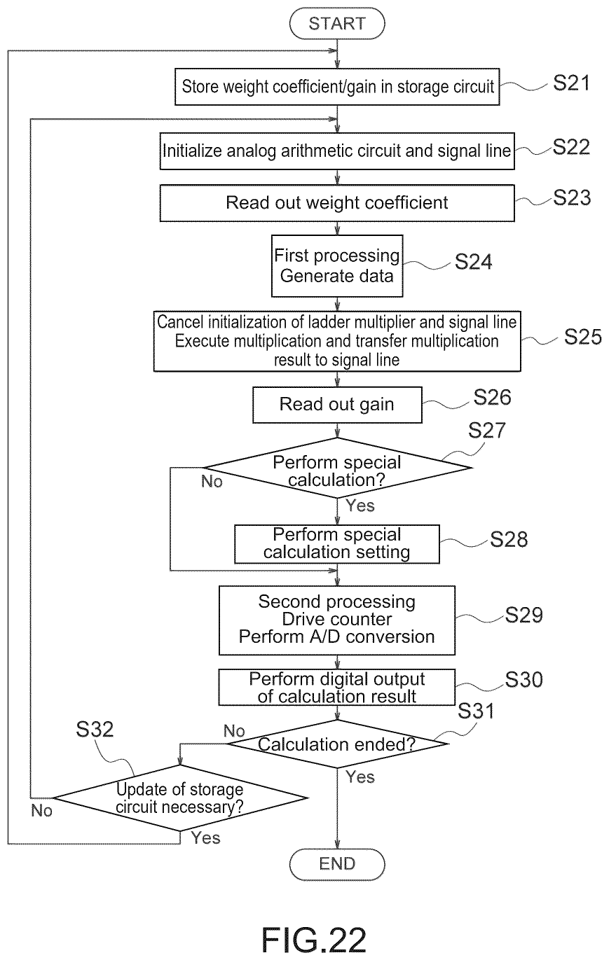

FIG. 22 is a flowchart showing an overall processing operation of the signal processing circuit 101 according to the third embodiment of the present disclosure. First, the signal processing circuit 101 writes, into the storage circuit 104, for example, the second digital signal W expressing a weight coefficient and the third digital signal G expressing a gain (Step S21). The timing for writing the second digital signal W and the third digital signal G into the storage circuit 104 is arbitrary. The second digital signal W and the third digital signal G may be written into the storage circuit 104 at a time the signal processing circuit 101 is manufactured or at a time of shipment, or a user may be enabled to arbitrarily change the settings of the second digital signal W and the third digital signal G after shipment.

Next, the DAC 107 turns on the transistors 145 shown in FIG. 15 and initializes each node on the signal path 146 of the ladder multiplier 108 in each of the plurality of analog arithmetic circuits 102 to, for example, the power supply voltage level (Step S22). Further, the analog arithmetic circuit 102 reads out the second digital signal W expressing the weight coefficient from the storage circuit 104 (Step S23). The read-out second digital signal W is input to the multiplexer 144. Next, in a stat where the signal line VSL is set to the initial voltage Vinitial, the analog arithmetic circuit 102 performs the first processing and generates the first analog signal CRow[i](Step S24).

The transistors 145 are turned off, and the initialization of the ladder multiplier 108 in the analog arithmetic circuit 102 and the signal line VSL is canceled (Step S25). Accordingly, the multiplication of the first analog signal CRow[i] and the second digital signal W is executed in parallel in the ladder multipliers 108 in the plurality of analog arithmetic circuits 102. As a result, a voltage Vout indicating the multiplication result is generated in each of the ladder multipliers 108. Moreover, the second analog signal Vvsla that is based on the product-sum operation result of the plurality of analog arithmetic circuits 102 is transferred to the signal line VSL, and the voltage of the signal line VSL is lowered at the same time.

Next, the analog arithmetic circuit 102 reads out the third digital signal G for setting a gain from the storage circuit 104 (Step S26). The voltage rising width for raising the voltage level of the signal line VSL stepwise can be variably controlled in accordance with the value of the third digital signal G.

Next, the signal processing circuit 101 determines whether or not to perform a special calculation (Step S27). The special calculation is, for example, a non-linear calculation such as the ReLU operation shown in FIG. 20F. When performing the special calculation, a special calculation setting is performed as necessary (Step S28). When performing the ReLU operation, the non-linear arithmetic control circuit 125 delays a count-up start timing of the counter 121. Further, when adding the previous product-sum operation results shown in FIG. 20G, processing of retaining the count value of the counter 121 without resetting the count value, or the like is performed.

When the signal processing circuit 101 does not perform the special calculation or after the setting of the special calculation in Step S28 is ended, the signal processing circuit 101 performs the fourth processing (Step S29). The plurality of analog arithmetic circuits 102 raise the voltage of the signal line VSL stepwise using the third digital signal G, and the counter 121 performs the count-up operation. Further, the comparison circuit 105 compares the voltage level of the fourth analog signal on the signal line VSL with the initial voltage Vinitial, and when the Vm signal, which is an output signal of the comparison circuit 105, is inverted, the latch circuit 106 latches the count value Cc of the counter 121 to generate the fourth digital signal Dc. That is, the ADC 111 performs AD conversion to generate the fourth digital signal Dc that is based on the product-sum operation result obtained in Step S25 (Step S30).

Next, the signal processing circuit 101 determines whether or not to end the calculation (Step S31). When continuing the calculation, the signal processing circuit 101 determines whether or not to update the second digital signal W and the third digital signal G in the storage circuit 104 (Step S32). When the second digital signal W and the third digital signal G are to be updated, the processing of Step S31 and subsequent steps is performed again. When the signals are not to be updated, the processing of Step S32 and subsequent steps is performed again.

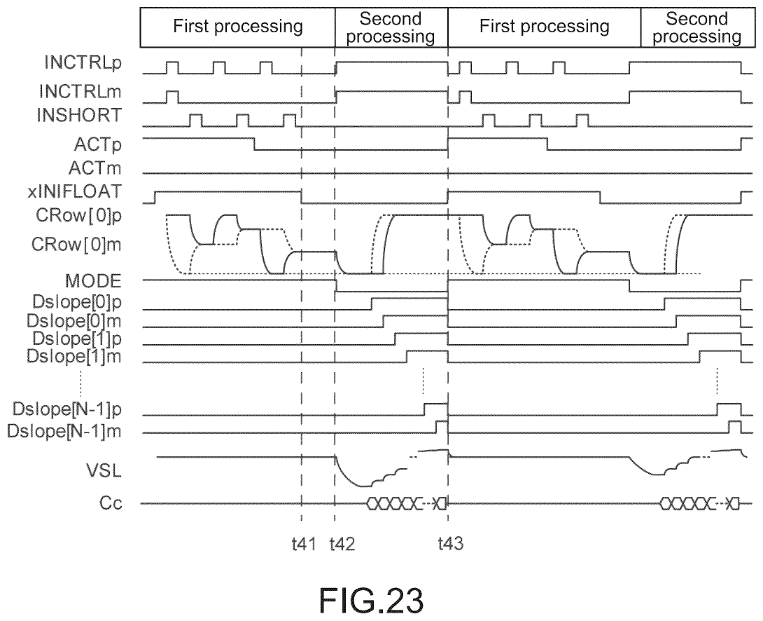

FIG. 23 is a timing chart showing an overall operation of the signal processing circuit 101 according to the third embodiment of the present disclosure. Until a time t41 in FIG. 23, the first analog signal CRow[i] is input to one ends of the capacitors 141a and 141b shown in FIG. 15. Meanwhile, since the transistors 145 are turned on, the voltage levels at the other ends of the capacitors 141a and 141b continue to be initialized at a predetermined voltage level (e.g., the level of the power supply voltage VDD). Accordingly, the ladder multiplier 108 does not start the multiplication operation.

At the time t41 in FIG. 23, the transistors 145 are turned off, and the ladder multiplier 108 can prepare for the multiplication operation (Step S25 in FIG. 22). Further, at a time t42, the MODE signal is turned off, and the second processing is started (Step S29 in FIG. 22). At a time t43, the second processing is ended, and a fourth digital signal indicating the product-sum operation result is output from the latch circuit 106 (Step S30 in FIG. 22). In the case of YES in Step S31 in FIG. 22, before the plurality of analog arithmetic circuits 102 start a new multiplication, the xINIFLOAT signal is set to a high level to turn on the transistors 145, and the voltage levels of the plurality of analog arithmetic circuits 102 and the signal line VSL are initialized to a predetermined voltage level (for example, the level of the power supply voltage VDD) (Step S22 in FIG. 22). After that, the operation up to the time t43 is repeated.

The operation before the time t41 is similar to that of the timing chart shown in FIG. 13. The operation from the time t41 to the time t43 in FIG. 23 is similar to that of the timing chart shown in FIG. 18.

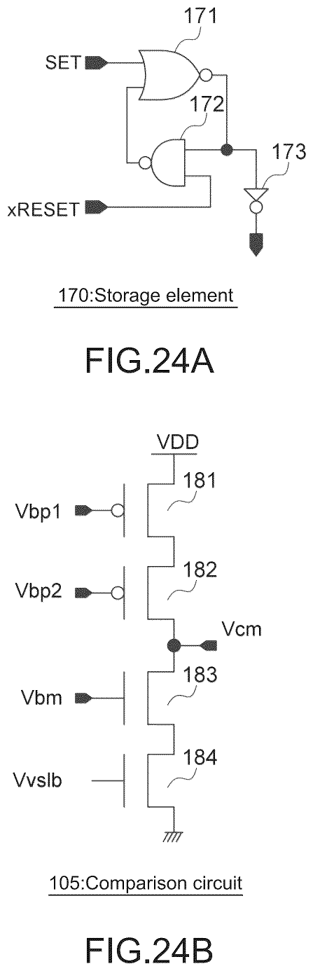

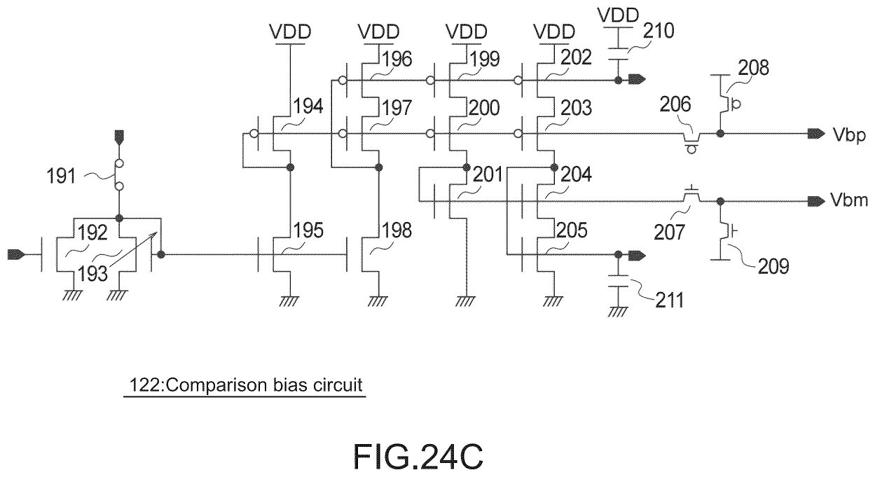

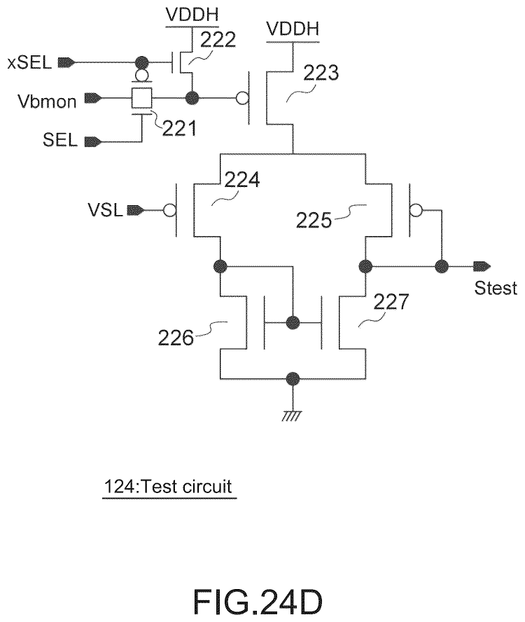

The storage circuit 104 shown in FIG. 9 is constituted of a plurality of bits and stores the second digital signal W and the third digital signal G. The weight coefficient storage circuit 163 and the gain storage circuit 162 in the storage circuit 104 include a large number of storage elements 170 that store the respective bit values of the second digital signal W and the third digital signal G. FIG. 24A is a circuit diagram of one storage element 170 in the storage circuit 104. The storage element 170 includes logic circuits 171, 172, and 173. The logic circuit 171 outputs, for example, a NOR signal of a SET signal and an output signal of the logic circuit 172. The logic circuit 172 outputs, for example, a NAND signal of an XRESET signal and an output signal of the logic circuit 171. The logic circuit 173 outputs, for example, an inverted signal of the output signal of the logic circuit 171. The SET signal is a data bit to be stored in the storage element 170. The XRESET signal is a signal for deleting a data bit stored in the storage element 170, and the deletion is executed when the signal is at a low level. It is noted that FIG. 24A is an example of the circuit configuration of the storage element 170, and various modified examples are applicable.

FIG. 24B is a circuit diagram showing the configuration of the comparison circuit 105. The comparison circuit 105 includes transistors 181, 182, 183, and 184 that are connected in series between the node of the power supply voltage VDD and the ground node. The transistors 181 and 182 are, for example, PMOS transistors, and the transistors 183 and 184 are, for example, NMOS transistors. A voltage Vbp1 that causes a bias current to flow is input to the gate of the transistor 181. For example, bias signals Vbp2 and Vbm from the comparison bias circuit 122 are input to the gates of the transistors 182 and 183, respectively. A fourth analog signal Vvslb is input to the gate of the transistor 184. A binary Vcm signal indicating a comparison result between the fourth analog signal Vvslb and the initial voltage Vinitial is output from a connection node of the transistors 182 and 183.

FIG. 24C is a diagram showing a configuration of the comparison bias circuit 122. The comparison bias circuit 122 includes a switch 191, transistors 192, 193, 194, 195, 196, 197, 198, 199, 200, 201, 202, 203, 204, 205, 206, 207, 208, and 209, and capacitors 210 and 211. The transistors 192, 193, 195, 198, 201, 204, 205, 207, and 209 are, for example, NMOS transistors. The transistors 194, 196, 197, 199, 200, 202, 203, 206, and 208 are, for example, PMOS transistors.

The transistors 193 and 195 constitute a current mirror circuit, and by controlling a current that flows between the drain and source of the transistor 193, a current that flows between the drain and source of the transistors 195 and 194 can be controlled. Accordingly, the voltage levels of the bias signals Vbp and Vbm can be controlled.

FIG. 24D is a circuit diagram showing a configuration of the test circuit 124 shown in FIG. 10. The test circuit 124 is provided for monitoring the voltage level on the signal line VSL. The test circuit 124 makes it easier to specify a location of a failure in the signal processing circuit 101.

The test circuit 124 monitors, for example, the second analog signal Vvsla. When an anomaly of the fourth digital signal Dc is found in a subsequent device or the like, it becomes easier to specify an anomalous part of the signal processing circuit 101 by referring to the test result of the test circuit 124. When the second analog signal Vvsla is anomalous, it can be determined that there has been an anomaly in the first processing and the product-sum operation of the plurality of analog arithmetic circuits 102. When there is no anomaly in the second analog signal Vvsla, it can be determined that there has been an anomaly in the second processing and AD. As described above, the test circuit 124 can isolate the location where the anomaly has occurred.

The test circuit 124 includes a transfer gate 221 and transistors 222, 223, 224, 225, 226, and 227. The transistors 223, 224, and 225 are each constituted of, for example, a PMOS transistor, and the transistors 222, 226, and 227 are each constituted of, for example, an NMOS transistor. A selection signal SEL and an inverted signal xSEL of the selection signal SEL are input to the gate of the transfer gate 221. The transfer gate 221 opens and takes in the Vbmon signal when a high-level selection signal SEL is input. When the selection signal SEL is of a high level, the transistor 222 is turned off. Therefore, the transistor 223 functioning as a current source causes a current corresponding to the voltage level of the Vbmon signal to flow. The voltage of the signal line VSL is input to the gate of the transistor 224. A current corresponding to the voltage level of the signal line VSL flows between the source and drain of the transistor 224. Since the transistors 226 and 227 constitute a current mirror circuit, a current proportional to the source-drain of the transistor 224 flows between the source and drain of the transistor 225. A gate voltage of the transistor 225 becomes a voltage level corresponding to the voltage of the signal line VSL. Therefore, by monitoring the gate voltage of the transistor 225, the voltage level of the signal line VSL can be detected.

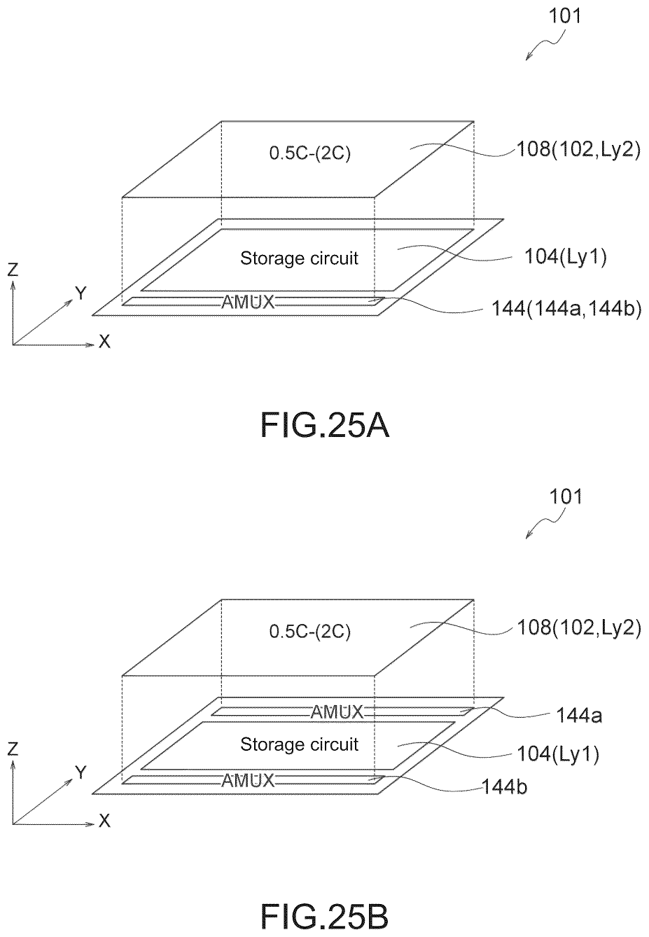

FIG. 25A is a diagram showing a first example of a substrate structure of the signal processing circuit 101 according to the third embodiment of the present disclosure. The analog arithmetic circuit 102 (ladder multiplier 108) and the storage circuit 104 are arranged in different layers of the same substrate, for example. Specifically, the storage circuit 104 is arranged in a first layer Ly1, and the analog arithmetic circuit 102 is arranged in a second layer Ly2.

It is noted that the analog arithmetic circuit 102 and the storage circuit 104 may be arranged on different substrates. Furthermore, the signal processing circuit 101 may have a structure in which a substrate on which the analog arithmetic circuit 102 is arranged and a substrate on which the storage circuit 104 is arranged are stacked.

The multiplexer 144 is arranged in, for example, the same layer as the storage circuit 104. FIG. 25A shows the example in which the first multiplexer 144a and the second multiplexer 144b are integrally arranged in the same region of the same layer.

FIG. 25B is a diagram showing a second example of the substrate structure of the signal processing circuit 101 according to the third embodiment of the present disclosure. FIG. 25B differs from FIG. 25A in that the first multiplexer 144a and the second multiplexer 144b are arranged while being separated from each other. In the example of FIG. 25B, the first multiplexer 144a and the second multiplexer 144b are arranged to oppose each other with the storage circuit 104 in between.

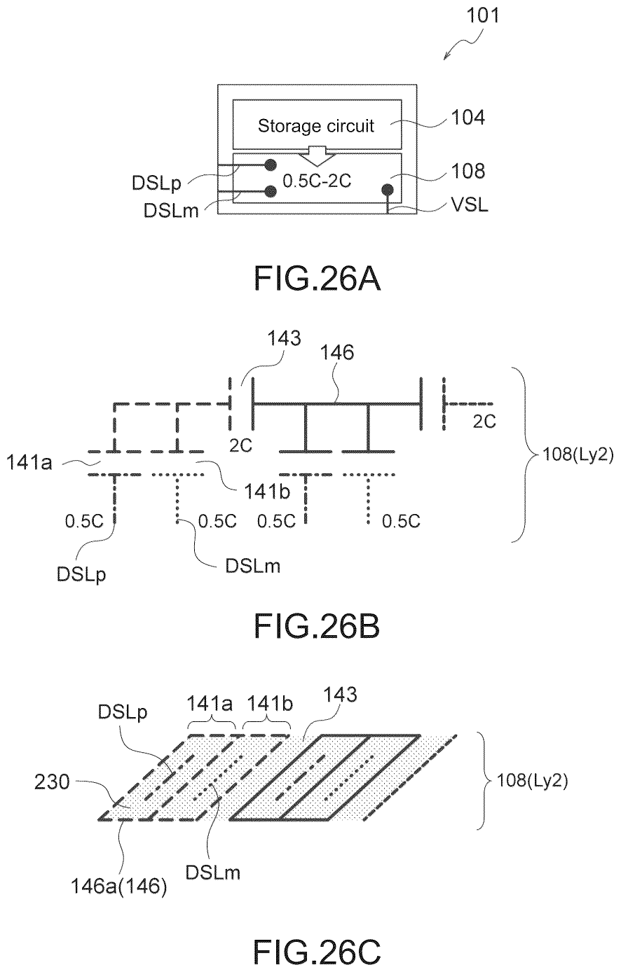

FIG. 26A is a plan view showing a first example of the signal processing circuit 101 according to the third embodiment of the present disclosure. FIG. 26A shows an example in which the storage circuit 104 and the ladder multiplier 108 are arranged close to each other in a planar direction.

FIG. 26B is a diagram showing a circuit structure of the ladder multiplier 108 shown in FIG. 26A. The circuit structure shown in FIG. 26B is similar to that of FIG. 15. FIG. 26B shows an example in which the capacitors 141a, 141b, and 143, the signal path 146, and the data lines DSLp and DSLm are arranged in a plane. FIG. 26C is a planar perspective view showing a wiring structure of the ladder multiplier 108 shown in FIG. 26B. In FIG. 26C, for example, a plurality of wiring layers 146a constituting the signal path 146 are arranged so as to respectively surround the plurality of data lines DSLp and the plurality of data lines DSLm. An insulation layer 230 is arranged between two adjacent wiring layers 146a, between the wiring layer 146a and the data line DSLp, and between the wiring layer 146a and the data line DSLm. The capacitor 141a is arranged between the wiring layer 146a and the data line DSLp. The capacitor 141b is arranged between the wiring layer 146a and the data line DSLm. The capacitor 143 is arranged between the adjacent wiring layers 146a. The capacitors 141a, 141b, and 143 and the wiring layers 146a are arranged in the second layer Ly2 shown in FIG. 25A.

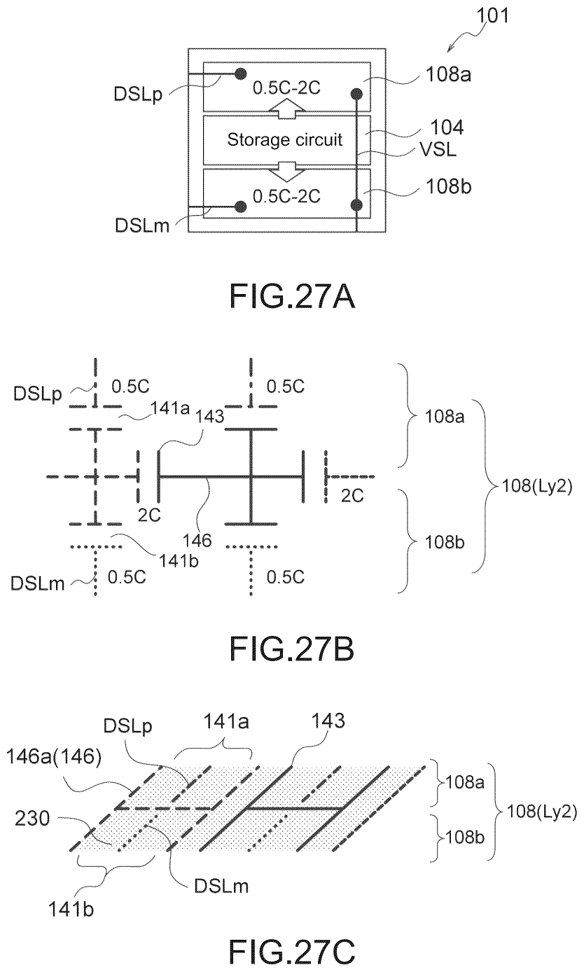

FIG. 27A is a plan view showing a second example of the signal processing circuit 101 according to the third embodiment of the present disclosure. FIG. 27A shows an example in which the ladder multiplier 108 is divided into two regions 108a and 108b. The regions 108a and 108b are arranged with the storage circuit 104 in between.

FIG. 27B is a diagram showing a circuit structure of the ladder multiplier 108 shown in FIG. 27A. FIG. 27B shows an example in which the capacitor 141a in the ladder multiplier 108 is arranged in the region 108a shown in FIG. 27A, and the capacitor 141b is arranged in the region 108b. FIG. 27C is a planar perspective view showing a wiring structure of the ladder multiplier 108 shown in FIG. 27B. FIG. 27C shows an example in which the data lines DSLp and DSLm are arranged to oppose each other with the wiring of the signal path 146 in between. Accordingly, the capacitors 141a and 141b are arranged to oppose each other with the wiring layer 146a in between.

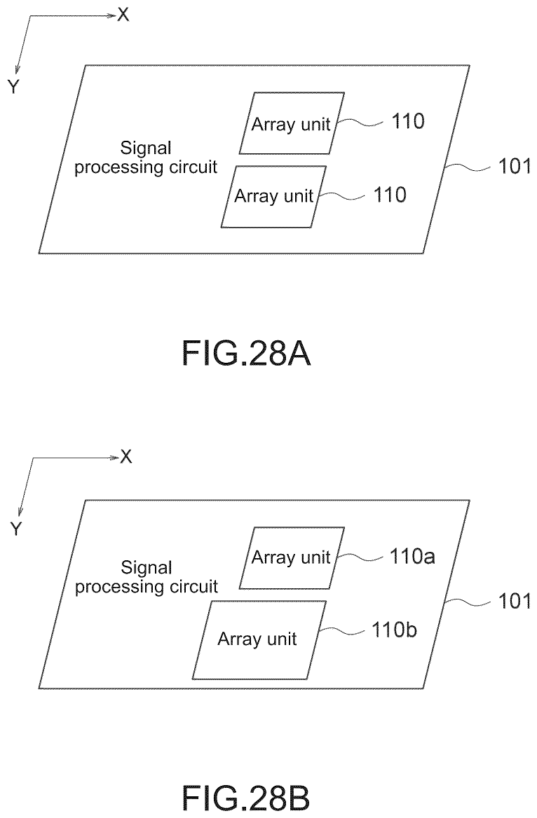

The signal processing circuit 101 may include a plurality of array units 110. FIG. 28A is a diagram showing a configuration in which the plurality of array units 110 of the same size are arranged. The plurality of array units 110 are arrayed in at least one of the first direction X or the second direction Y (the second direction Y in the example of FIG. 28A). The plurality of array units 110 include the same number of analog arithmetic circuits 102. The signal processing circuit 101 can improve the arithmetic speed by, for example, performing calculations in parallel using the plurality of array units 110.

FIG. 28B is a diagram showing a configuration in which the plurality of array units 110 of different sizes are arranged. FIG. 28B shows a small-sized array unit 110a and a large-sized array unit 110b. In the example of FIG. 28B, the array units 110a and 110b are arrayed in the second direction Y. The array unit 110b has a larger number of analog arithmetic circuits 102 arranged therein than the array unit 110a. The array unit 110a is used in a mobile net (MobileNet), for example, and performs lightweight and high-speed calculations such as Depthwise Separable Convolution. The array unit 110b is used for high-level calculations such as FCN (Fully Convolutional Network).

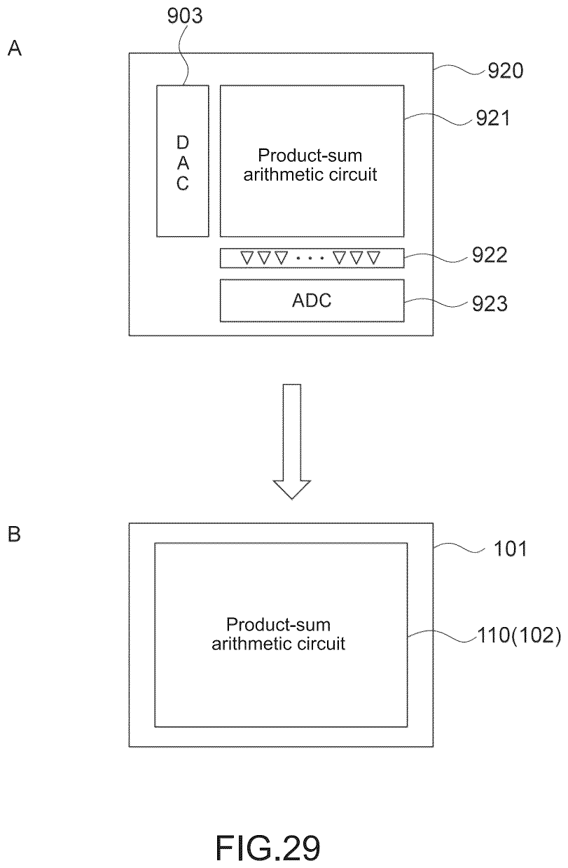

FIG. 29 are diagrams showing a difference between the signal processing circuit 101 according to the third embodiment of the present disclosure and a signal processing circuit 920 according to a comparative example. FIG. 29A shows the signal processing circuit 920 according to the comparative example, and FIG. 29B shows the signal processing circuit 101 according to the third embodiment of the present disclosure.

The signal processing circuit 920 includes a product-sum arithmetic circuit 921 constituted of the multiplier 900 shown in FIG. 16, for example. The product-sum arithmetic circuit 921 does not have a DA conversion function for converting a digital signal into an analog signal to use it in the product-sum operation and/or an AD conversion function for converting the analog product-sum operation result into a digital signal. Therefore, the signal processing circuit 920 requires a DAC 903, a gain setting circuit 922, and an ADC 923, thereby increasing the circuit area.

In contrast, the array unit (product-sum arithmetic circuit) 110 according to the third embodiment of the present disclosure can perform DA conversion of the first digital signal ACTp by the first processing, and can perform AD conversion of the fourth analog signal Vvslb by the second processing. Therefore, the signal processing circuit 101 does not require the DAC 903, the gain setting circuit 922, and the ADC 923, and thus can save the area as compared to the signal processing circuit 920.

As described above, the signal processing circuit 101 according to the third embodiment of the present disclosure includes the plurality of analog arithmetic circuits 102 and the ADC 111. Each of the analog arithmetic circuits 102 includes the DAC 107 and the ladder multiplier 108. The DAC 107 performs the first processing for DA-converting the first digital signal ACTp into the first analog signal CRow[i] by redistributing capacitances using the capacitors 141a and 141b in the ladder multiplier 108. The ladder multiplier 108 performs the second processing for varying the second analog signal Vvsla generated by multiplying the first analog signal CRow[i] and the second digital signal W, based on the third digital signal G for setting a gain, to generate the third analog signal Vg[0]. The voltage level of the signal line VSL to which the plurality of analog arithmetic circuits 102 are connected is lowered from the initial voltage Vinitial based on the plurality of second analog signals Vvsla, and is then raised stepwise based on the third analog signal Vg[0] generated by each of the ladder multipliers 108, to generate a fourth analog signal Vvslb. The comparison circuit 105 in the ADC 111 compares the voltage level of the fourth analog signal Vvslb with the initial voltage Vinitial, and generates a Vcm signal indicating the comparison result. The latch circuit 106 in the ADC 111 latches the count value Cc of the counter 121 at the timing when the Vcm signal transitions from a high level to a low level, to generate a fourth digital signal Dc.

According to the third embodiment of the present disclosure, since some of the capacitors 141a and 141b constituting the ladder multiplier 108 in each of the analog arithmetic circuits 102 are diverted to perform the DA conversion of the first digital signal ACTp into the first analog signal CRow[i], it is possible to reduce the circuit scale of the DAC 107 and realize miniaturization of the signal processing circuit 101 as compared to a case of providing a dedicated DAC.

Further, by switching the input of the multiplexer 144 connected to the ladder multiplier 108 in each of the analog arithmetic circuits 102 from the second digital signal W to the third digital signal G, a gain during the AD conversion can be changed, and the resolution of the signal of the product-sum result during the AD conversion can be made variable.

Since the voltage level on the signal line VSL can be varied according to the product-sum operation result and the variation of the voltage level on the signal line VSL falls within a certain range from the initial voltage Vinitial, power consumption can be reduced.

It is noted that the signal processing circuit 101 may omit either the first processing or the second processing. For example, the first processing may be omitted, and the DAC 903 and/or the like may be provided. Further, the second processing may be omitted, and the ADC 923 and/or the like may be provided.

Alternatively, the first processing may be realized by applying the first and second embodiments of the present disclosure. That is, the multiplier shown in FIG. 1 and the capacitance selection units 13a to 13c shown in FIGS. 2A to 2C or FIG. 8 may be applied to the ladder multiplier 108 shown in FIG. 15 and the like.

### Fourth Embodiment

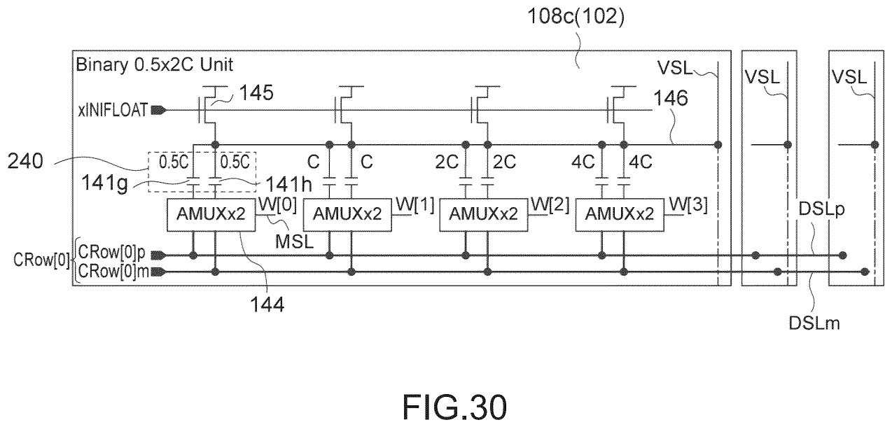

FIG. 30 is a circuit diagram showing a ladder multiplier 108c according to a fourth embodiment of the present disclosure. The ladder multiplier 108c shown in FIG. 30 differs from the ladder multiplier 108 shown in FIG. 15 in the point of not including the capacitors 142 and 143. In addition, the ladder multiplier 108c includes capacitors 141g and 141h respectively corresponding to the capacitors 141a and 141b shown in FIG. 30. One capacitor 141g and one capacitor 141h adjacent to the capacitor 141g constitute one capacitor group 240.

The ladder multiplier 108c includes a plurality of capacitor groups 240. The capacitors 141g and 141h belonging to the same capacitor group 240 have the same capacitance. In addition, in the different capacitor groups 240, the capacitances of the capacitors 141g and 141h differ by a power of two. In the example of FIG. 30, the capacitors 141g and 141h with a capacitance of 0.5C, the capacitors 141g and 141h with a capacitance of C, the capacitors 141g and 141h with a capacitance of 2C, and the capacitors 141g and 141h with a capacitance of 4C are arranged.

The multiplexer 144 is provided for each of the capacitor groups 240. Voltages corresponding to the respective bits of the second digital signal W are input to the multiplexers 144 in accordance with the order of the capacitances of the corresponding capacitor groups 240. Specifically, a voltage corresponding to the least significant bit of the second digital signal W is input to the multiplexer 144 connected to the capacitor group 240 with the smallest capacitance, and a voltage corresponding to the most significant bit of the second digital signal W is input to the multiplexer 144 connected to the capacitor group 240 with the largest capacitance.

Similar to the ladder multiplier 108 shown in FIG. 15, the ladder multiplier 108c is used in the first processing, the multiplication of the second digital signal W and the first analog signal CRow[i], and the second processing. In addition, the ladder multiplier 108c can perform a product-sum operation similar to that shown in Expression (3) above, and can output a second analog signal Vvsla similar to that shown in Expression (2) to the signal line VSL.

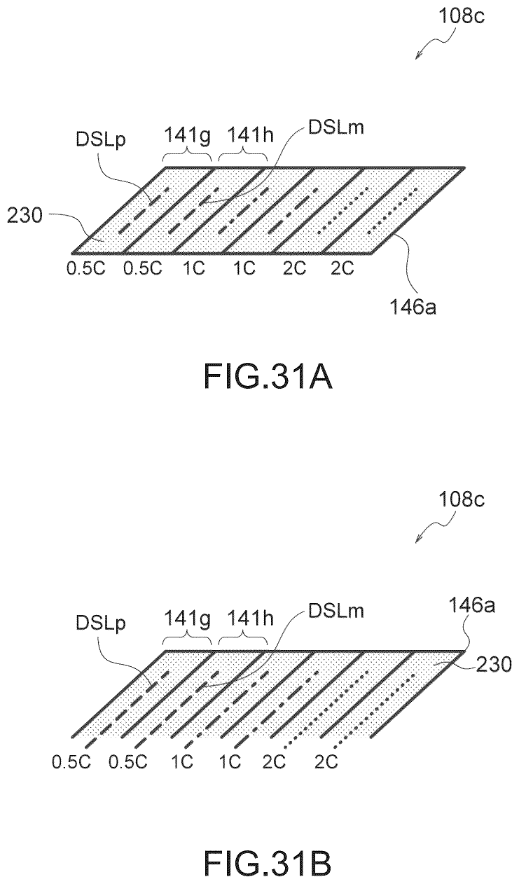

FIG. 31A is a planar perspective view showing a first example of a wiring structure of the ladder multiplier 108c. FIG. 31B is a planar perspective view showing a second example of the wiring structure of the ladder multiplier 108c. The wiring structures shown in FIGS. 31A and 31B respectively correspond to the wiring structures shown in FIGS. 26C and 27C.

In the analog arithmetic circuit 102 shown in FIG. 15, the capacitors 141a and 141b need to strictly adjust the capacitance between the capacitors 142 and 143. On the other hand, the ladder multiplier 108c shown in FIG. 30 does not need to perform such an adjustment and has a characteristic that the ladder multiplier 108c is less susceptible to an influence of noise due to an error in the capacitance of the capacitors. Further, in the ladder multiplier 108c shown in FIG. 30, the capacitors do not need to be arranged in the ascending order of the capacitance from the right side of FIG. 30. Therefore, a degree of freedom in the circuit layout is higher than that of the analog arithmetic circuit 102 shown in FIG. 15. It is noted that as described above, a bit of the second digital signal W that corresponds to the capacitance of the connected capacitor group 240 needs to be input to the multiplexer 144.

Similar to the third embodiment of the present disclosure, the capacitance selection units 13a to 13c shown in FIGS. 2A to 2C or FIG. 8 may be applied to the capacitor groups 240 shown in FIG. 30.

### Application Examples

The technology according to the present disclosure can be applied to various products. For example, the technology according to the present disclosure may be realized as a device mounted on any type of mobile body, such as an automobile, an electric vehicle, a hybrid electric vehicle, a motorcycle, a bicycle, personal mobility, an airplane, a drone, a ship, a robot, a construction machine, or an agricultural machine (tractor).

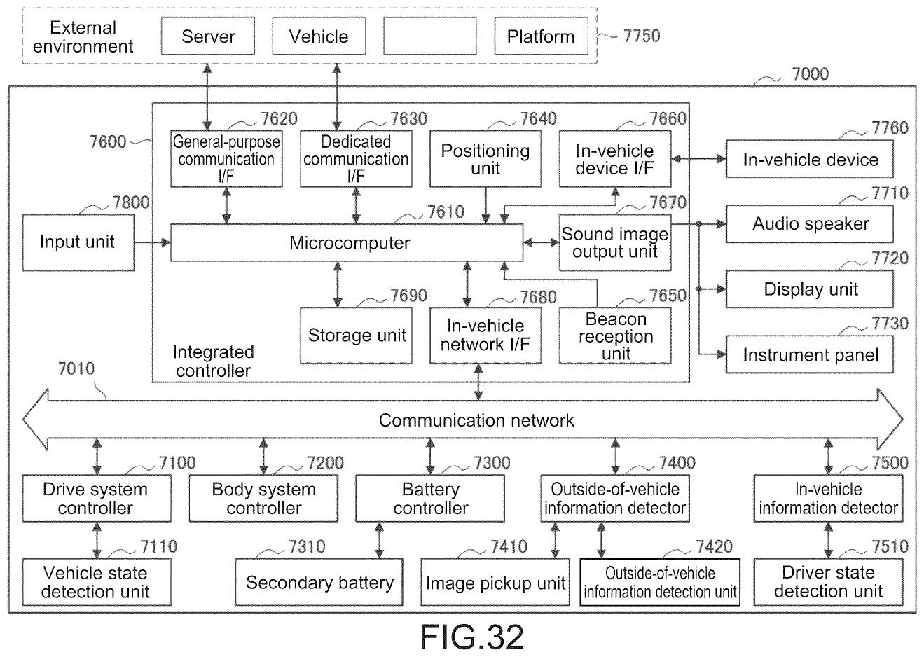

FIG. 32 is a block diagram showing a schematic configuration example of a vehicle control system 7000, which is an example of a mobile body control system to which the technology according to the present disclosure may be applied. The vehicle control system 7000 includes a plurality of electronic controllers connected via a communication network 7010. In the example shown in FIG. 32, the vehicle control system 7000 includes a drive system controller 7100, a body system controller 7200, a battery controller 7300, an outside-of-vehicle information detector 7400, an in-vehicle information detector 7500, and an integrated controller 7600. The communication network 7010 that connects these plurality of controllers may be, for example, an in-vehicle communication network compliant with an arbitrary standard such as a CAN (Controller Area Network), a LIN (Local Interconnect Network), a LAN (Local Area Network), or FlexRay®.

Each of the controllers includes a microcomputer that performs arithmetic processing according to various programs, a storage unit that stores the programs to be executed by the microcomputer, parameters to be used in various calculations, and the like, and a drive circuit that drives various control target devices. Each of the controllers includes a network I/F for communicating with the other controllers via the communication network 7010, and a communication I/F for communicating with devices, sensors, and/or the like inside and outside of the vehicle by wired communication or wireless communication. FIG. 32 shows, as the functional configuration of the integrated controller 7600, a microcomputer 7610, a general-purpose communication I/F 7620, a dedicated communication I/F 7630, a positioning unit 7640, a beacon reception unit 7650, an in-vehicle device I/F 7660, an sound image output unit 7670, an in-vehicle network I/F 7680, and a storage unit 7690. Other controllers also similarly include a microcomputer, a communication I/F, a storage unit, and the like.

The drive system controller 7100 controls operations of devices related to a drive system of the vehicle according to various programs. For example, the drive system controller 7100 functions as a control device for a driving force generation device for generating a driving force of the vehicle, such as an internal combustion engine or a driving motor, a driving force transmission mechanism for transmitting the driving force to the wheels, a steering mechanism for adjusting a steering angle of the vehicle, a brake device for generating a braking force of the vehicle, and the like. The drive system controller 7100 may have a function as a control device such as an ABS (Antilock Brake System) or an ESC (Electronic Stability Control).

A vehicle state detection unit 7110 is connected to the drive system controller 7100. The vehicle state detection unit 7110 includes, for example, at least one of a gyro sensor that detects an angular velocity of an axial rotation motion of a vehicle body, an acceleration sensor that detects an acceleration of the vehicle, or a sensor for detecting an operation amount of an accelerator pedal, an operation amount of a brake pedal, a steering angle of a steering wheel, an engine speed, a wheel rotation speed, or the like. The drive system controller 7100 performs arithmetic processing using signals input from the vehicle state detection unit 7110, and controls the internal combustion engine, the driving motor, the electronic power steering device, the brake device, and/or the like.

The body system controller 7200 controls operations of various devices equipped in the vehicle body according to various programs. For example, the body system controller 7200 functions as a control device for a keyless entry system, a smart key system, a power window device, or various lights such as headlights, backlights, brake lights, blinkers, and fog lights. In this case, radio waves transmitted from a mobile device that replaces a key or signals of various switches may be input to the body system controller 7200. The body system controller 7200 accepts the input of these radio waves or signals and controls the door lock device, power window device, lights, and the like of the vehicle.

The battery controller 7300 controls a secondary battery 7310, which is a power supply source for the driving motor, according to various programs. For example, information on a battery temperature, a battery output voltage, a remaining capacity of the battery, and/or the like is input to the battery controller 7300 from a battery device including the secondary battery 7310. The battery controller 7300 performs arithmetic processing using these signals, and performs temperature adjustment control of the secondary battery 7310 or control of a cooling device or the like included in the battery device.

The outside-of-vehicle information detector 7400 detects external information of the vehicle equipped with the vehicle control system 7000. For example, at least one of an image pickup unit 7410 or an outside-of-vehicle information detection unit 7420 is connected to the outside-of-vehicle information detector 7400. The image pickup unit 7410 includes at least one of a ToF (Time Of Flight) camera, a stereo camera, a monocular camera, an infrared camera, or other cameras. The outside-of-vehicle information detection unit 7420 includes, for example, at least one of an environment sensor for detecting a current weather or meteorological phenomenon, or a surrounding information detection sensor for detecting other vehicles, obstacles, pedestrians, and/or the like around the vehicle equipped with the vehicle control system 7000.

The environment sensor may be, for example, at least one of a rain drop sensor that detects a rainy weather, a fog sensor that detects fog, a sunshine sensor that detects a sunshine degree, or a snow sensor that detects snowfall. The surrounding information detection sensor may be at least one of an ultrasonic sensor, a radar device, or a LIDAR (Light Detection and Ranging, Laser Imaging Detection and Ranging) device. The image pickup unit 7410 and the outside-of-vehicle information detection unit 7420 may be provided as independent sensors or devices, or may be provided as a device in which a plurality of sensors or devices are integrated.

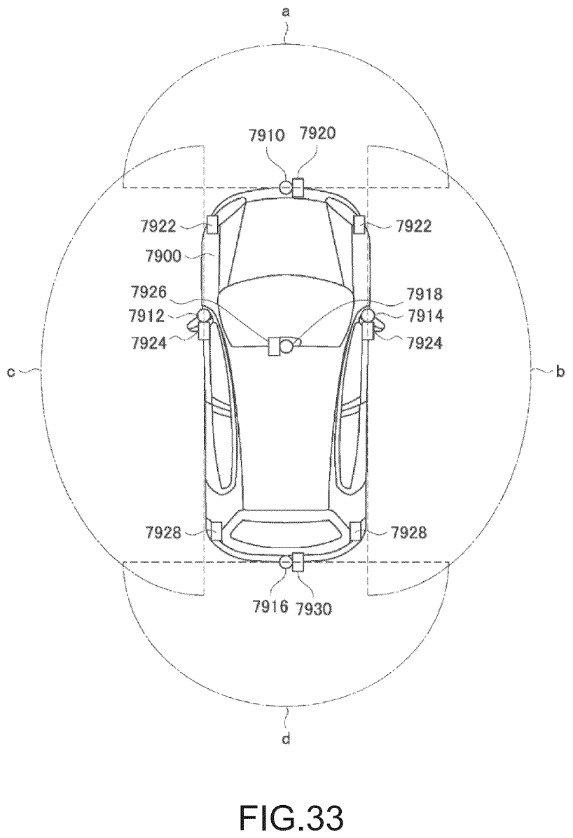

Here, FIG. 33 shows an example of installation positions of the image pickup unit 7410 and the outside-of-vehicle information detection unit 7420. Image pickup units 7910, 7912, 7914, 7916, and 7918 are each provided at, for example, at least one of the front nose, side mirror, rear bumper, or back door of the vehicle 7900 or an upper portion of a windshield in a vehicle interior. The image pickup unit 7910 provided in the front nose and the image pickup unit 7918 provided at the upper portion of the windshield in the vehicle interior mainly acquire images of the front of the vehicle 7900. The image pickup units 7912 and 7914 provided in the side mirrors mainly acquire images of the sides of the vehicle 7900. The image pickup unit 7916 provided in the rear bumper or the back door mainly acquires images of the rear of the vehicle 7900. The image pickup unit 7918 provided at the upper portion of the windshield in the vehicle interior is mainly used to detect a preceding vehicle, a pedestrian, an obstacle, a traffic light, a traffic sign, a lane, and/or the like.

It is noted that FIG. 33 shows an example of image pickup ranges of the image pickup units 7910, 7912, 7914, and 7916. The image pickup range a indicates the image pickup range of the image pickup unit 7910 provided in the front nose, the image pickup ranges b and c indicate the image pickup ranges of the image pickup units 7912 and 7914 provided in the side mirrors, and image pickup range d indicates the image pickup range of the image pickup unit 7916 provided in the rear bumper or the back door. For example, pieces of image data captured by the image pickup units 7910, 7912, 7914, and 7916 are superimposed to obtain a bird's-eye view image of the vehicle 7900 as viewed from above.

The outside-of-vehicle information detection units 7920, 7922, 7924, 7926, 7928, and 7930 provided at the front, rear, sides, and corners of the vehicle 7900 and the upper portion of the windshield in the vehicle interior may be, for example, ultrasonic sensors or radar devices. The outside-of-vehicle information detection units 7920, 7926, and 7930 provided in the front nose, rear bumper, and back door of the vehicle 7900 and the upper portion of the windshield in the vehicle interior may be, for example, LIDAR devices. These outside-of-vehicle information detection units 7920 to 7930 are mainly used to detect a preceding vehicle, a pedestrian, an obstacle, and/or the like.

Returning to FIG. 32, the descriptions will be continued. The outside-of-vehicle information detector 7400 causes the image pickup unit 7410 to capture an image outside the vehicle and receives the captured image data. The outside-of-vehicle information detector 7400 also receives detection information from the outside-of-vehicle information detection unit 7420 connected thereto. When the outside-of-vehicle information detection unit 7420 is an ultrasonic sensor, a radar device, or a LIDAR device, the outside-of-vehicle information detector 7400 causes ultrasonic waves, electromagnetic waves, or the like to be transmitted, and receives information of the received reflected waves. The outside-of-vehicle information detector 7400 may perform object detection processing or distance detection processing of people, cars, obstacles, signs, characters on road surfaces, and/or the like based on the received information. The outside-of-vehicle information detector 7400 may also perform environment recognition processing for recognizing rainfall, fog, road surface conditions, and/or the like based on the received information. The outside-of-vehicle information detector 7400 may also calculate a distance to an object outside the vehicle based on the received information.

The outside-of-vehicle information detector 7400 may also perform image recognition processing or distance detection processing for recognizing people, cars, obstacles, signs, characters on road surfaces, and/or the like based on received image data. The outside-of-vehicle information detector 7400 may perform processing of distortion correction, positioning, and/or the like on the received image data, and synthesize the image data captured by the different image pickup units 7410, to generate a bird's-eye view image or a panoramic image. The outside-of-vehicle information detector 7400 may also perform viewpoint conversion processing using the image data captured by the different image pickup units 7410.

The in-vehicle information detector 7500 detects information inside the vehicle. For example, a driver state detection unit 7510 that detects a state of a driver is connected to the in-vehicle information detector 7500. The driver state detection unit 7510 may include a camera that captures an image of a driver, a biosensor that detects biological information of the driver, a microphone that collects sound, and/or the like. The biosensor is provided in, for example, a seat, a steering wheel, and/or the like, and detects biological information of a passenger sitting in the seat or a driver holding the steering wheel. The in-vehicle information detector 7500 may calculate a degree of fatigue or a degree of concentration of the driver or may determine whether or not the driver is dozing off based on the detection information input from the driver state detection unit 7510. The in-vehicle information detector 7500 may perform processing such as noise canceling processing on the collected sound signal.

The integrated controller 7600 controls the overall operation of the vehicle control system 7000 according to various programs. An input unit 7800 is connected to the integrated controller 7600. The input unit 7800 is realized by, for example, a device with which an input operation can be made by a driver or passenger, such as a touch panel, a button, a microphone, a switch, or a lever. Data obtained by performing sound recognition of sound input by a microphone may be input to the integrated controller 7600. The input unit 7800 may be, for example, a remote control device that uses infrared rays or other radio waves, or may be an external connection device such as a mobile phone or a PDA (Personal Digital Assistant) that supports the operation of the vehicle control system 7000. The input unit 7800 may be, for example, a camera, and in that case, the driver or passenger can input information by gestures. Alternatively, data obtained by detecting a movement of a wearable device worn by the driver or passenger may be input. Furthermore, the input unit 7800 may include, for example, an input control circuit that generates an input signal based on information input by the driver or passenger, or the like using the input unit 7800 described above, and outputs the input signal to the integrated controller 7600, and/or the like. The driver or passenger, or the like operates this input unit 7800 to input various types of data to the vehicle control system 7000 and/or instruct the vehicle control system 7000 to perform processing operations.

The storage unit 7690 may include a ROM (Read Only Memory) that stores the various programs to be executed by the microcomputer, and a RAM (Random Access Memory) that stores various parameters, arithmetic results, sensor values, and the like. Further, the storage unit 7690 may be realized by a magnetic storage device such as an HDD (Hard Disc Drive), a semiconductor storage device, an optical storage device, a magneto-optical storage device, or the like.

The general-purpose communication I/F 7620 is a general-purpose communication I/F that mediates communication between various devices present in an external environment 7750. The general-purpose communication I/F 7620 may implement a cellular communication protocol such as GSM® (Global System of Mobile communications), WiMAX®, LTE© (Long Term Evolution), or LTE-A (LTE-Advanced), or other wireless communication protocols such as a wireless LAN (also called Wi-Fi®) and Bluetooth®. The general-purpose communication I/F 7620 may connect to devices present on an external network (e.g., the Internet, a cloud network, or a business-operator-specific network) (e.g., application server or control server) via a base station or an access point, for example. In addition, the general-purpose communication I/F 7620 may connect to a terminal present in the vicinity of the vehicle (e.g., a terminal of a driver, a pedestrian, or a store, or an MTC (Machine Type Communication) terminal) using a P2P (Peer To Peer) technology, for example.

The dedicated communication I/F 7630 is a communication I/F that supports a communication protocol designed for use in a vehicle. The dedicated communication I/F 7630 may implement, for example, a standard protocol such as WAVE (Wireless Access in Vehicle Environment), DSRC (Dedicated Short Range Communications), or a cellular communication protocol, which is a combination of a lower layer IEEE 802.11p and an upper layer IEEE 1609. The dedicated communication I/F 7630 typically performs V2X communication, which is a concept including one or more of vehicle-to-vehicle communication, vehicle-to-infrastructure communication, vehicle-to-home communication, and vehicle-to-pedestrian communication.

The positioning unit 7640 executes positioning by receiving, for example, a GNSS (Global Navigation Satellite System) signal (e.g., a GPS signal from a GPS (Global Positioning System) satellite) from a GNSS satellite, and generates position information including a latitude, longitude, and altitude of the vehicle. It is noted that the positioning unit 7640 may specify a current position by exchanging signals with a wireless access point, or acquire position information from a terminal such as a mobile phone, a PHS, or a smartphone having a positioning function.

The beacon reception unit 7650 receives, for example, radio waves or electromagnetic waves transmitted from a wireless station or the like installed on a road, and acquires information on a current position, traffic jam, road closure, required time, and/or the like. It is noted that the function of the beacon reception unit 7650 may alternatively be included in the dedicated communication I/F 7630 described above.

The in-vehicle device I/F 7660 is a communication interface that mediates connections between the microcomputer 7610 and the various in-vehicle devices 7760 present in the vehicle. The in-vehicle device I/F 7660 may establish a wireless connection using a wireless communication protocol such as a wireless LAN, Bluetooth®, NFC (Near Field Communication), or WUSB (Wireless USB). In addition, the in-vehicle device I/F 7660 may establish a wired connection such as a USB (Universal Serial Bus), an HDMI (High-Definition Multimedia Interface), or an MHL (Mobile High-definition Link) via a connection terminal (and a cable if necessary) (not shown). The in-vehicle device 7760 may include, for example, at least one of a mobile device or wearable device owned by a driver or passenger, or an information device carried into or attached to the vehicle. The in-vehicle device 7760 may also include a navigation device that searches for a route to an arbitrary destination. The in-vehicle device I/F 7660 exchanges control signals or data signals with these in-vehicle devices 7760.

The in-vehicle network I/F 7680 is an interface that mediates communication between the microcomputer 7610 and the communication network 7010. The in-vehicle network I/F 7680 transmits and receives signals and/or the like in accordance with a predetermined protocol supported by the communication network 7010.

The microcomputer 7610 of the integrated controller 7600 controls the vehicle control system 7000 according to various programs based on information acquired via at least one of the general-purpose communication I/F 7620, the dedicated communication I/F 7630, the positioning unit 7640, the beacon reception unit 7650, the in-vehicle device I/F 7660, or the in-vehicle network I/F 7680. For example, the microcomputer 7610 may calculate a control target value of the driving force generation device, the steering mechanism, or the brake device based on the acquired information of the inside and outside of the vehicle, and output a control command to the drive system controller 7100. For example, the microcomputer 7610 may perform cooperative control for the purpose of realizing ADAS (Advanced Driver Assistance System) functions including collision avoidance or impact mitigation of a vehicle, inter-vehicle distance control, vehicle speed control, vehicle collision warning, lane departure warning, and the like. In addition, the microcomputer 7610 may perform cooperative control for the purpose of automated driving and/or the like in which the vehicle travels autonomously without relying on a driver operation, by controlling the driving force generation device, the steering mechanism, the brake device, or the like based on the acquired information around the vehicle.

The microcomputer 7610 may generate, based on information acquired via at least one of the general-purpose communication I/F 7620, the dedicated communication I/F 7630, the positioning unit 7640, the beacon reception unit 7650, the in-vehicle device I/F 7660, or the in-vehicle network I/F 7680, three-dimensional distance information between the vehicle and an object such as a peripheral structure or a person, and create local map information including peripheral information of the current position of the vehicle. The microcomputer 7610 may also predict dangers such as a vehicle collision, approach of a pedestrian, and entry into a closed road based on the acquired information, and generate a warning signal. The warning signal may be, for example, a signal for generating a warning sound or a signal for turning on a warning lamp.

The sound image output unit 7670 transmits an output signal of at least one of sound or image to an output device capable of visually or auditorily notifying the driver or passenger of the vehicle or the outside of the vehicle of the information. In the example of FIG. 32, an audio speaker 7710, a display unit 7720, and an instrument panel 7730 are exemplified as the output device. The display unit 7720 may include, for example, at least one of an on-board display or a head-up display. The display unit 7720 may have an AR (Augmented Reality) display function. The output device may be devices other than these devices, such as headphones, a wearable device such as a glasses-type display worn by the driver or passenger, a projector, and a lamp. When the output device is a display device, the display device visually displays the results obtained by the various types of processing performed by the microcomputer 7610 or information received from other controllers in various forms such as texts, images, tables, and graphs. Alternatively, when the output device is a sound output device, the sound output device converts an audio signal constituted of reproduced audio data, acoustic data, or the like into an analog signal and auditorily outputs the signal.

It is noted that in the example shown in FIG. 32, at least two controllers connected via the communication network 7010 may be integrated as one controller. Alternatively, the individual controllers may each be constituted of a plurality of controllers. Further, the vehicle control system 7000 may include another controller (not shown). Furthermore, some or all of the functions assumed by one of the controllers may be given to another controller. In other words, as long as information is transmitted and received via the communication network 7010, predetermined arithmetic processing may be performed by any of the controllers. Similarly, a sensor or device connected to one of the controllers may be connected to another controller, and the plurality of controllers may mutually transmit and receive detection information via the communication network 7010.

In the vehicle control system 7000 described above, the signal processing circuit 101 according to the present embodiment described with reference to FIG. 9 can be applied to the image pickup unit 7410 of the application example shown in FIG. 32. For example, by applying the signal processing circuit 101 according to the present embodiment in the image processing of the image pickup unit 7410, it becomes possible to realize image processing calculations with low power consumption.

It is noted that the present technology can also take the following configurations.
(1) An arithmetic apparatus, including:
   a first capacitor connected between a first node and a reference voltage node;
   a plurality of second capacitors connected in series to a signal path between the first node and a second node; and
   a plurality of third capacitors having one ends connected to connection nodes of the first capacitor and the plurality of second capacitors, in which
   a first digital signal is used to set which of a voltage corresponding to a second digital signal and a predetermined reference voltage is to be applied to other ends of the plurality of third capacitors, and
   the second node outputs a voltage corresponding to a multiplication result of the first digital signal and the second digital signal.
(2) The arithmetic apparatus according to (1), in which
   the one ends of two or more of the third capacitors are connected to each of the connection node between the first node and the second capacitor adjacent to the first node, the connection node between the two second capacitors adjacent to each other, and the connection node between the second node and the second capacitor adjacent to the second node on the signal path.
(3) The arithmetic apparatus according to (2), in which
   the second digital signal includes a plurality of bits, and
   each of the bits of the second digital signal is used for setting a voltage of the other ends of the two or more third capacitors in the connection nodes that differ.
(4) The arithmetic apparatus according to (3), in which
   a plurality of the connection nodes are provided on the signal path, and
   the voltage corresponding to the second digital signal or the predetermined reference voltage is applied to the other ends of the two or more third capacitors connected to each of the plurality of connection nodes, according to corresponding bit values of the same first digital signal.
(5) The arithmetic apparatus according to any one of (2) to (4), in which
   the two or more third capacitors have a same capacitance value.
(6) The arithmetic apparatus according to (5), in which
   a sum of the capacitance values of the two or more third capacitors is equal to a capacitance value of the first capacitor.
(7) The arithmetic apparatus according to (5) or (6), in which
   the first digital signal is a thermometer code.
(8) The arithmetic apparatus according to any one of (2) to (4), in which
   the plurality of third capacitors have mutually-different capacitance values that each are one over a power of two of a capacitance value of the first capacitor.
(9) The arithmetic apparatus according to any one of (2) to (8), in which
   a voltage corresponding to a same bit value of the second digital signal is applied to the other ends of the plurality of third capacitors having the one ends connected to the same connection node on the signal path, and
   voltages corresponding to mutually-different bit values of the second digital signal are applied to the other ends of the plurality of third capacitors having the one ends connected to the connection nodes that mutually differ on the signal path.
(10) The arithmetic apparatus according to (9), in which
   capacitance values of the plurality of second capacitors are the same.
(11) The arithmetic apparatus according to (10), in which
   the capacitance values of the second capacitors are twice a capacitance value of the first capacitor.
(12) The arithmetic apparatus according to any one of (1) to (11), further including:
   an array unit including a plurality of multipliers arrayed in a first direction and a second direction that intersect with each other, in which
   each of the plurality of multipliers includes the first capacitor, the plurality of second capacitors, and the plurality of third capacitors.
(13) The arithmetic apparatus according to (12), in which
   the array unit includes a signal wiring to which the second node of each of two or more of the multipliers arrayed in the first direction or the second direction is connected, and
   the signal wiring has a voltage corresponding to a value obtained by adding multiplication results of the two or more multipliers or an addition average value of the multiplication results.
(14) The arithmetic apparatus according to (13), including
   an analog-to-digital converter which is connected to the signal wiring and converts a voltage on the signal wiring into a digital signal.
(15) The arithmetic apparatus according to (12), in which
   the array unit includes a signal wiring to which the second node of each of two or more of the multipliers arrayed in the first direction or the second direction is connected, and
   the arithmetic apparatus further includes:
   an integrator which adds signals output to the signal wiring; and
an analog-to-digital converter which converts a voltage output from the integrator into a digital signal.
(16) The arithmetic apparatus according to (14) or (15), including
   a signal processing unit which performs predetermined signal processing on the basis of a digital signal of a product-sum operation value obtained by adding the multiplication results of the plurality of multipliers, the digital signal having been output from the analog-to-digital converter.
(17) The arithmetic apparatus according to (16), in which
   the array unit, the analog-to-digital converter, and the signal processing unit are arranged divisionally on two or more stacked semiconductor substrates.
(18) The arithmetic apparatus according to any one of (12) to (17), including
   a storage unit which stores at least one of the first digital signal or the second digital signal, in which
   the plurality of multipliers read out at least one of the first digital signal or the second digital signal stored in the storage unit, to perform a multiplication.
(19) The arithmetic apparatus according to any one of (1) to (18), including
   a capacitance initialization circuit which initializes accumulated charges of the plurality of third capacitors before performing the multiplication of the first digital signal and the second digital signal.
(20) A signal processing apparatus, including:
   an arithmetic apparatus; and
   an image pickup unit which outputs captured image data, in which
   the arithmetic apparatus includes
   a first capacitor connected between a first node and a reference voltage node,
   a plurality of second capacitors connected in series to a signal path between the first node and a second node, and
   a plurality of third capacitors having one ends connected to connection nodes of the first capacitor and the plurality of second capacitors,
   a first digital signal is used to set which of a voltage corresponding to a second digital signal and a predetermined reference voltage is to be applied to other ends of the plurality of third capacitors,
   the second node outputs a voltage corresponding to a multiplication result of the first digital signal and the second digital signal, and
   at least one of the first digital signal or the second digital signal is a signal that is based on the image data.
(21) A signal processing circuit, including:
   an analog arithmetic circuit which performs first processing for converting a first digital signal into a first analog signal, and performs second processing for varying a second analog signal corresponding to a multiplied value of the first analog signal obtained by the conversion and a second digital signal on the basis of a third digital signal for setting a gain, to generate a third analog signal.
(22) The signal processing circuit according to (21), further including:
   a plurality of the analog arithmetic circuits that separately perform the first processing and the second processing;
   a signal line which transmits a fourth analog signal of a signal level in which a plurality of the second analog signals or a plurality of the third analog signals respectively output from the plurality of analog arithmetic circuits are added; and
   an analog-to-digital converter circuit which converts the fourth analog signal obtained by the second processing into a fourth digital signal.
(23) The signal processing circuit according to (22), in which
   the second processing includes third processing for simultaneously lowering a voltage level on the signal line on the basis of a plurality of the first analog signals, and fourth processing for raising, after the third processing, a voltage of the signal line stepwise on the basis of each of a plurality of the third digital signals, to generate the fourth analog signal.
(24) The signal processing circuit according to (23), further including:
   a control circuit which controls the plurality of analog arithmetic circuits, in which
   the control circuit causes the plurality of analog arithmetic circuits to perform the first processing and the third processing in parallel, and causes the plurality of analog arithmetic circuits to sequentially perform the fourth processing.
(25) The signal processing circuit according to (24), in which
   the control circuit initializes a plurality of the fourth analog signals output from the plurality of analog arithmetic circuits to a predetermined voltage level before starting a new multiplication of the first digital signal and the second digital signal.
(26) The signal processing circuit according to any one of (22) to (25), in which
   each of the plurality of analog arithmetic circuits includes
   two or more first capacitors which accumulate a charge corresponding to the first digital signal, and
   a switch which connects the two or more first capacitors in parallel or causes one or more of the two or more first capacitors to charge or discharge in accordance with the first digital signal, and makes a switch as to whether or not to set the remaining first capacitors in a floating state.
(27) The signal processing circuit according to (26), in which
   each of the plurality of analog arithmetic circuits includes a ladder multiplication circuit which includes a plurality of second capacitors which are connected in series and each output a voltage that is one over a power of two, one end of the ladder multiplication circuit being connected to the signal line.
(28) The signal processing circuit according to (27), in which
   the two or more first capacitors are connected between two of the second capacitors adjacent to each other out of the plurality of second capacitors,
   the two or more first capacitors have a same capacitance, and
   each of the plurality of second capacitors has a capacitance that is twice or more of the capacitance of the first capacitors.
(29) The signal processing circuit according to (26), further including:
   a plurality of capacitor groups each including the two or more first capacitors, in which
   one end of each of the two or more first capacitors in each of the plurality of capacitor groups is connected to the signal line,
   the two or more first capacitors in each of the plurality of capacitor groups have a same capacitance, and
   the capacitances of the two or more first capacitors in each of the plurality of capacitor groups differ by a power of two.
(30) The signal processing circuit according to any one of (26) to (29), including
   a storage unit which stores the second digital signal, in which
   at least some of the capacitors including the first capacitor, that are included in the plurality of analog arithmetic circuits, are arranged in a second layer different from a first layer in which the storage unit is arranged.
(31) The signal processing circuit according to (30), in which
   the at least some of the capacitors including the first capacitor, that are included in the plurality of analog arithmetic circuits, include
   a plurality of wiring layers arranged in the second layer, and
   an insulation layer arranged between the plurality of wiring layers.
(32) The signal processing circuit according to any one of (22) to (31), in which
   each of the plurality of analog arithmetic circuits extends in a first direction, and
   the signal processing circuit includes
   an array unit including the plurality of analog arithmetic circuits arrayed in a second direction intersecting with the first direction.
(33) The signal processing circuit according to (32), including
   a plurality of the array units arrayed in at least one of the first direction or the second direction, in which
   the plurality of array units include a same number of the plurality of analog arithmetic circuits, or
   at least some of the plurality of array units include the plurality of analog arithmetic circuits in a number different from that of the remaining array units.
(34) The signal processing circuit according to any one of (22) to (33), in which
   the analog-to-digital converter circuit includes a comparison circuit which determines whether or not the fourth analog signal on the signal line has exceeded a predetermined threshold value.
(35) The signal processing circuit according to (34), in which
   the analog-to-digital converter circuit includes a counter which performs a count operation until it is determined by the comparison circuit that the fourth analog signal has exceeded the predetermined threshold value since start of an analog-to-digital conversion operation, and outputs the fourth digital signal corresponding to a count value of the counter.
(36) The signal processing circuit according to (35), in which
   a cycle at which each of the plurality of analog arithmetic circuits sequentially performs the second processing to vary a voltage level of the signal line is the same as or is different from a count cycle of the counter.
(37) The signal processing circuit according to any one of (22) to (36), in which
   a voltage level of the signal line to be varied by each of the plurality of analog arithmetic circuits by the second processing is determined by the third digital signal.
(38) The signal processing circuit according to any one of (22) to (37), including
   a non-linear arithmetic circuit which performs non-linear arithmetic processing on the fourth digital signal output from the analog-to-digital converter circuit.
(39) The signal processing circuit according to (38), in which
   the non-linear arithmetic circuit outputs the fourth digital signal as it is when the fourth digital signal is a positive value, and outputs 0 when the fourth digital signal is a negative value.
(40) The signal processing circuit according to any one of (22) to (39), including
   a monitor circuit which monitors the voltage level of the signal line.

The modes of the present disclosure are not limited to the individual embodiments described above and include various modifications that may be conceived by a person skilled in the art, and the effects of the present disclosure are also not limited to the contents described above. In other words, various additions, modifications, and partial deletions can be made without departing from the conceptual idea and gist of the present disclosure that are derived from the contents defined in the scope of claims and equivalents thereof.

### REFERENCE SIGNS LIST

1, 90 multiplier
2 product-sum array unit
3 analog-to-digital converter
4 signal processing unit
5 storage unit
6 integrator
7 gain calculator
10, 10a, 10b, 80 arithmetic apparatus
11 first capacitor
12 second capacitor
13, 13a, 13b, 13c capacitance selection unit
14, 14a third capacitor
15, 92 inverter
18 capacitance initialization circuit
16, 17, 19 transistor
21 signal wiring
22, 91 capacitor
23 switch
24 amplifier
30 signal processing apparatus
31, 32, 32a, 32b substrate
33 light-receiving unit
34 image processing unit
81 digital-to-analog converter
101, 920 signal processing circuit
102 analog arithmetic circuit
103 control circuit
104 storage circuit
105 comparison circuit
106 latch circuit
107, 903 DAC
107a first DAC processing unit
107b second DAC processing unit
108, 108c ladder multiplier
108a, 108b region
110, 110a, 110b array unit
111, 923 ADC
112 non-linear calculator
121 counter
122 comparison bias circuit
123 selection switch
124 test circuit
125 non-linear arithmetic control circuit
130, 151a, 151b, 191, 902 switch
131a, 131b, 132a, 132b, 133a, 133b, 171, 172, 173 logic circuit
134a, 134b inverter
141a, 141b, 141c, 141d, 141e, 141f, 141g, 141h, 142, 143, 210,
211, 901 capacitor
144 multiplexer
144a first multiplexer
144b second multiplexer
145, 152a, 152b, 181, 182, 183, 184, 192, 193, 194, 195, 196,
197, 198, 199, 200, 201, 202, 203, 204, 205, 206, 207, 208, 209,
222, 223, 224, 225, 226, 227 transistor
146 signal path
146a wiring layer
147 bit multiplication unit
161 logic circuit
162 gain storage circuit
163 weight coefficient storage circuit
164 output circuit
170 storage element
221 transfer gate
230 insulation layer
240 capacitor group
900 multiplier
921 product-sum arithmetic circuit
922 gain setting circuit

1. An arithmetic apparatus, comprising:
a first capacitor connected between a first node and a reference voltage node;
a plurality of second capacitors connected in series to a signal path between the first node and a second node; and
a plurality of third capacitors having one ends connected to connection nodes of the first capacitor and the plurality of second capacitors, wherein
a first digital signal is used to set which of a voltage corresponding to a second digital signal and a predetermined reference voltage is to be applied to other ends of the plurality of third capacitors, and
the second node outputs a voltage corresponding to a multiplication result of the first digital signal and the second digital signal.

2. The arithmetic apparatus according to claim 1, wherein
the one ends of two or more of the third capacitors are connected to each of the connection node between the first node and the second capacitor adjacent to the first node, the connection node between the two second capacitors adjacent to each other, and the connection node between the second node and the second capacitor adjacent to the second node on the signal path.

3. The arithmetic apparatus according to claim 2, wherein
the second digital signal includes a plurality of bits, and
each of the bits of the second digital signal is used for setting a voltage of the other ends of the two or more third capacitors in the connection nodes that differ.

4. The arithmetic apparatus according to claim 3, wherein
a plurality of the connection nodes are provided on the signal path, and
the voltage corresponding to the second digital signal or the predetermined reference voltage is applied to the other ends of the two or more third capacitors connected to each of the plurality of connection nodes, according to corresponding bit values of the same first digital signal.

5. The arithmetic apparatus according to claim 2, wherein
the two or more third capacitors have a same capacitance value, and
a sum of the capacitance values of the two or more third capacitors is equal to a capacitance value of the first capacitor.

6. The arithmetic apparatus according to claim 2, wherein
the plurality of third capacitors have mutually-different capacitance values that each are one over a power of two of a capacitance value of the first capacitor.

7. The arithmetic apparatus according to claim 2, wherein
a voltage corresponding to a same bit value of the second digital signal is applied to the other ends of the plurality of third capacitors having the one ends connected to the same connection node on the signal path, and
voltages corresponding to mutually-different bit values of the second digital signal are applied to the other ends of the plurality of third capacitors having the one ends connected to the connection nodes that mutually differ on the signal path.

8. The arithmetic apparatus according to claim 7, wherein
capacitance values of the plurality of second capacitors are the same, and
the capacitance values of the second capacitors are twice a capacitance value of the first capacitor.

9. The arithmetic apparatus according to claim 1, further comprising:
an array unit including a plurality of multipliers arrayed in a first direction and a second direction that intersect with each other, wherein
each of the plurality of multipliers includes the first capacitor, the plurality of second capacitors, and the plurality of third capacitors.

10. A signal processing apparatus, comprising:
an arithmetic apparatus; and
an image pickup unit which outputs captured image data, wherein
the arithmetic apparatus includes
a first capacitor connected between a first node and a reference voltage node,
a plurality of second capacitors connected in series to a signal path between the first node and a second node, and
a plurality of third capacitors having one ends connected to connection nodes of the first capacitor and the plurality of second capacitors,
a first digital signal is used to set which of a voltage corresponding to a second digital signal and a predetermined reference voltage is to be applied to other ends of the plurality of third capacitors,
the second node outputs a voltage corresponding to a multiplication result of the first digital signal and the second digital signal, and
at least one of the first digital signal or the second digital signal is a signal that is based on the image data.

11. A signal processing circuit, comprising:
an analog arithmetic circuit which performs first processing for converting a first digital signal into a first analog signal, and performs second processing for varying a second analog signal corresponding to a multiplied value of the first analog signal obtained by the conversion and a second digital signal on a basis of a third digital signal for setting a gain, to generate a third analog signal.

12. The signal processing circuit according to claim 11, further comprising:
a plurality of the analog arithmetic circuits that separately perform the first processing and the second processing;
a signal line which transmits a fourth analog signal of a signal level in which a plurality of the second analog signals or a plurality of the third analog signals respectively output from the plurality of analog arithmetic circuits are added; and
an analog-to-digital converter circuit which converts the fourth analog signal obtained by the second processing into a fourth digital signal.

13. The signal processing circuit according to claim 12, wherein
the second processing includes third processing for simultaneously lowering a voltage level on the signal line on the basis of a plurality of the first analog signals, and fourth processing for raising, after the third processing, a voltage of the signal line stepwise on the basis of each of a plurality of the third digital signals, to generate the fourth analog signal.

14. The signal processing circuit according to claim 13, further comprising:
a control circuit which controls the plurality of analog arithmetic circuits, wherein
the control circuit causes the plurality of analog arithmetic circuits to perform the first processing and the third processing in parallel, and causes the plurality of analog arithmetic circuits to sequentially perform the fourth processing.

15. The signal processing circuit according to claim 12, wherein
each of the plurality of analog arithmetic circuits includes
two or more first capacitors which accumulate a charge corresponding to the first digital signal, and
a switch which connects the two or more first capacitors in parallel or causes one or more of the two or more first capacitors to charge or discharge in accordance with the first digital signal, and makes a switch as to whether or not to set the remaining first capacitors in a floating state.

16. The signal processing circuit according to claim 15, wherein
each of the plurality of analog arithmetic circuits includes a ladder multiplication circuit which includes a plurality of second capacitors which are connected in series and each output a voltage that is one over a power of two, one end of the ladder multiplication circuit being connected to the signal line.

17. The signal processing circuit according to claim 16, wherein
the two or more first capacitors are connected between two of the second capacitors adjacent to each other out of the plurality of second capacitors,
the two or more first capacitors have a same capacitance, and
each of the plurality of second capacitors has a capacitance that is twice or more of the capacitance of the first capacitors.

18. The signal processing circuit according to claim 15, further comprising:
a plurality of capacitor groups each including the two or more first capacitors, wherein
one end of each of the two or more first capacitors in each of the plurality of capacitor groups is connected to the signal line,
the two or more first capacitors in each of the plurality of capacitor groups have a same capacitance, and
the capacitances of the two or more first capacitors in each of the plurality of capacitor groups differ by a power of two.

19. The signal processing circuit according to claim 12, wherein
the analog-to-digital converter circuit includes
a comparison circuit which determines whether or not the fourth analog signal on the signal line has exceeded a predetermined threshold value, and
a counter which performs a count operation until it is determined by the comparison circuit that the fourth analog signal has exceeded the predetermined threshold value since start of an analog-to-digital conversion operation, and
the analog-to-digital converter circuit outputs the fourth digital signal corresponding to a count value of the counter.

20. The signal processing circuit according to claim 12, wherein
a voltage level of the signal line to be varied by each of the plurality of analog arithmetic circuits by the second processing is determined by the third digital signal.
